(19) United States
(12) Patent Application Publication
(10) Pub. No.: US 2025/0385774 A1
(43) Pub. Date: Dec. 18, 2025

(54) METHODS FOR DISCOVERY AND SIGNALING PROCEDURE FOR NETWORK-ASSISTED CLUSTERED FEDERATED LEARNING

(71) Applicant: QUALCOMM Incorporated, San Diego, CA (US)

(72) Inventors: Mahmoud ASHOUR, San Diego, CA (US); Kyle Chi GUAN, New York, NY (US); Kapil GULATI, Belle Mead, NJ (US); Anantharaman BALASUBRAMANIAN, San Diego, CA (US); Hui GUO, Beijing (CN)

(21) Appl. No.: 18/880,171

(22) PCT Filed: Aug. 19, 2022
(86) PCT No.: PCT/CN2022/113664

§ 371 Date: Dec. 30, 2024

(51) Int. Cl. H04L 5/00; G06N 20/00; H04W 72/30

(52) U.S. Cl. CPC H04L 5/0055; G06N 20/00; H04L 5/0091; H04W 72/30

(57) ABSTRACT

Signaling procedures are provided which allow UEs to be formed into clusters via network assistance and perform ML model training in a clustered FL environment. A UE provides a first message including FL information to a network node. The UE also provides a second message indicating the network node. The UE obtains a third message indicating this network node or a different network node as an FL cluster leader and indicating an FL cluster of the UE based on the FL information. As a result, ML model training may be achieved in a distributed manner using clustered FL with minimization or avoidance of bottlenecks, communication overhead, challenges to model training due to heterogeneity of computational resources, training data, training tasks, or associated ML models, security and privacy challenges, or other limitations associated with conventional FL.

### BACKGROUND

### Technical Field

The present disclosure generally relates to communication systems, and more particularly, to wireless communication systems between a user equipment (UE) and a network entity such as a base station (BS) or a road side unit (RSU) for clustered federated learning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Federated learning (FL) refers to a machine learning technique in which multiple decentralized nodes holding local data samples may train a global machine learning (ML) model (e.g., a classifier or other model applied by multiple network nodes) without exchanging the data samples themselves between nodes to perform the training. However, conventional FL architectures rely on a centralized server to create, aggregate, and refine a global ML model for participating nodes, thus necessitating the transmission of locally trained ML models from participating nodes to the server during an FL iteration. This centralized approach to FL may have various drawbacks or limits, including bottlenecks from single points of failure, significant communication overhead, challenges to model training due to heterogeneity of computational resources, training data, training tasks, or associated ML models, and security and privacy challenges.

To address these limits associated with conventional FL architectures, a clustered or hierarchical approach to FL may be applied in which learning nodes working towards a common learning task are grouped together into clusters served by cluster leaders. The cluster formation and leader selection are network-assisted (e.g., via messages circulated within the network identifying clusters and confirming cluster leaders). The designated cluster leader for a cluster, rather than a FL parameter server directly, coordinates the learning task including local ML model training and updates within that cluster. After clusters are formed, the FL parameter server may coordinate the learning task including global ML model training and updates between clusters. The cluster leaders may thus act as intermediaries between the learning nodes and the FL parameter server for coordinating neural network training and optimization between different clusters. As a result, neural network training may be achieved in a distributed manner using clustered FL with minimal bottlenecks, minimal communication overhead, minimal challenges to model training due to heterogeneity of computational resources, training data, training tasks, or associated ML models, and minimal security and privacy challenges that may arise in conventional FL. Aspects of the disclosure accordingly provide various examples of signaling procedures between network nodes to implement clustered FL.

In an aspect of the disclosure, a method, a computer-readable medium, and an apparatus are provided. The apparatus may be a UE. The apparatus includes a processor, and memory coupled with the processor. The processor is configured to provide a first message including federated learning (FL) information, provide a second message indicating a first network node, and obtain a third message indicating one of the first network node or a second network node as an FL cluster leader and indicating an FL cluster of the apparatus in response to the FL information.

In an aspect of the disclosure, a method, a computer-readable medium, and an apparatus are provided. The apparatus may be a road side unit (RSU) or a base station. The apparatus includes a processor, and memory coupled with the processor. The processor is configured to obtain a first message including FL information of a first network node, and provide a second message indicating an FL cluster of the first network node in response to the FL information, where the second message indicates one of the apparatus or a second network node as an FL cluster leader of the FL cluster.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrate example aspects of a sidelink slot structure.

FIG. 4 is a diagram illustrating an example of a first device and a second device involved in wireless communication, e.g., in an access network.

FIG. 5 is a conceptual diagram of an example Open Radio Access Network architecture.

FIG. 6 is a diagram illustrating an example of a neural network.

FIG. 7 is a diagram illustrating an example of an FL architecture.

FIGS. 8A and 8B are diagrams illustrating examples of an FL architecture in different applications.

FIG. 9 is a diagram illustrating an example of a clustered FL architecture.

FIG. 10 is a diagram illustrating an example of a signaling procedure for network-assisted cluster formation and leader selection.

FIG. 11 is a diagram illustrating another example of a signaling procedure for network-assisted cluster formation and leader selection.

FIG. 12 is a diagram illustrating an example of a signaling procedure for intra-cluster FL following selection of a leader node.

FIG. 13 is a diagram illustrating an example of a signaling procedure for inter-cluster FL following one or more iterations of intra-cluster FL.

FIG. 14 is a flowchart of a method of wireless communication at a UE.

FIGS. 15A-15B are a flowchart of a method of wireless communication at a network node, e.g., a road side unit or edge server, or a FL parameter network entity, e.g., a base station.

FIG. 16 is a diagram illustrating an example of a hardware implementation for an example apparatus.

FIG. 17 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Federated learning (FL) refers to a machine learning technique in which multiple decentralized nodes holding local data samples may train a global machine learning (ML) model (e.g., a classifier or other model applied by multiple network nodes) without exchanging the data samples themselves between nodes to perform the training. A FL framework includes multiple network nodes or entities, namely a centralized aggregation server and participating FL devices (i.e., participants or nodes such as UEs). The FL framework enables the FL devices to learn a global ML model by allowing for the passing of messages between the devices through the central aggregation server or coordinator, which may be configured to communicate with the various FL devices and coordinate the learning framework. Nodes in the FL environment may process their own datasets and perform local updates to the global ML model, and the central server may aggregate the local updates and provide an updated global ML model to the nodes for further training or predictions.

However, conventional FL architectures rely on a centralized server to create, aggregate, and refine a global ML model for participating nodes, thus necessitating the transmission of locally trained ML models from participating nodes to the server during an FL iteration. This centralized approach to FL may have various drawbacks or limits. In one example, since the centralized server is the sole aggregator for the participating nodes, the centralized server may serve as a single point of failure for the FL system. As a result, if the centralized server ceases to operate at any time, a bottleneck could arise in the entire FL process. In another example, since a participant sends its local model updates to the centralized server, significant communication overhead may arise in applications where the volume of ML model information outweighs the raw data itself. In further examples, statistical challenges in model training may arise due to the heterogeneity of computational resources existing for different participants, the heterogeneity of training data available to participants, and the heterogeneity of training tasks and associated models configured for different participants. In another example, even though raw data is not directly communicated between nodes in FL, security and privacy concerns may still arise from the exchange of ML model parameters (e.g. due to leakage of information about underlying data samples).

To address these limits associated with conventional FL architectures, a clustered or hierarchical approach to FL may be applied in which learning nodes working towards a common learning task are grouped together into clusters. In one example, a FL parameter server (e.g., a base station) may group network nodes (e.g., UEs) together into clusters led by designated cluster leaders (e.g., road side units, edge servers, or other network nodes). In another example, a network node (e.g., a road side unit) may itself form and lead a cluster with other network nodes (e.g., UEs), without base station involvement. In either example, the cluster formation and leader selection are network-assisted (e.g., via messages circulated within the network identifying clusters and confirming cluster leaders). The designated cluster leader for a cluster, rather than the FL parameter server directly, coordinates the learning task including local ML model training and updates within that cluster. This coordination is referred to as intra-cluster FL. After clusters are formed, the FL parameter server may coordinate the learning task including global ML model training and updates between clusters. This coordination is referred to as inter-cluster FL. The cluster leaders may thus act as intermediaries between the learning nodes and the FL parameter server for coordinating neural network training and optimization between different clusters. As a result, neural network training may be achieved in a distributed manner using clustered FL with minimal bottlenecks, minimal communication overhead, minimal challenges to model training due to heterogeneity of computational resources, training data, training tasks, or associated ML models, and minimal security and privacy challenges that may arise in conventional FL.

Various examples of signaling procedures between network nodes (e.g. a UE, road side unit, and base station) are provided in order to implement clustered FL. In one example, a signaling procedure for cluster formation and leader selection is provided in which nodes participating in the ML training tasks are grouped together into clusters with other nodes (with network involvement) led by selected cluster leaders (ML model weight aggregators) for respective clusters based on configured criteria. In another example, a signaling procedure for cluster formation and leader selection is provided in which nodes participating in the ML training tasks may join clusters led by other nodes in response to respective requests from the other nodes. In a further example, upon completion of cluster formation and leader selection, a signaling procedure for clustered FL training may be provided in which nodes may perform intra-FL training coordinated by a cluster leader within a respective cluster through message passing between learning nodes and the cluster leader. In a further example, upon completion of cluster formation and leader selection, a signaling procedure for clustered FL training may be provided in which nodes may perform inter-FL training coordinated by an FL parameter server across different clusters through message exchanges between respective cluster leaders and the FL parameter server. The foregoing examples of signaling procedures may apply downlink/uplink communication (over a Uu interface) between UEs and a network entity such as a base station or road side unit.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

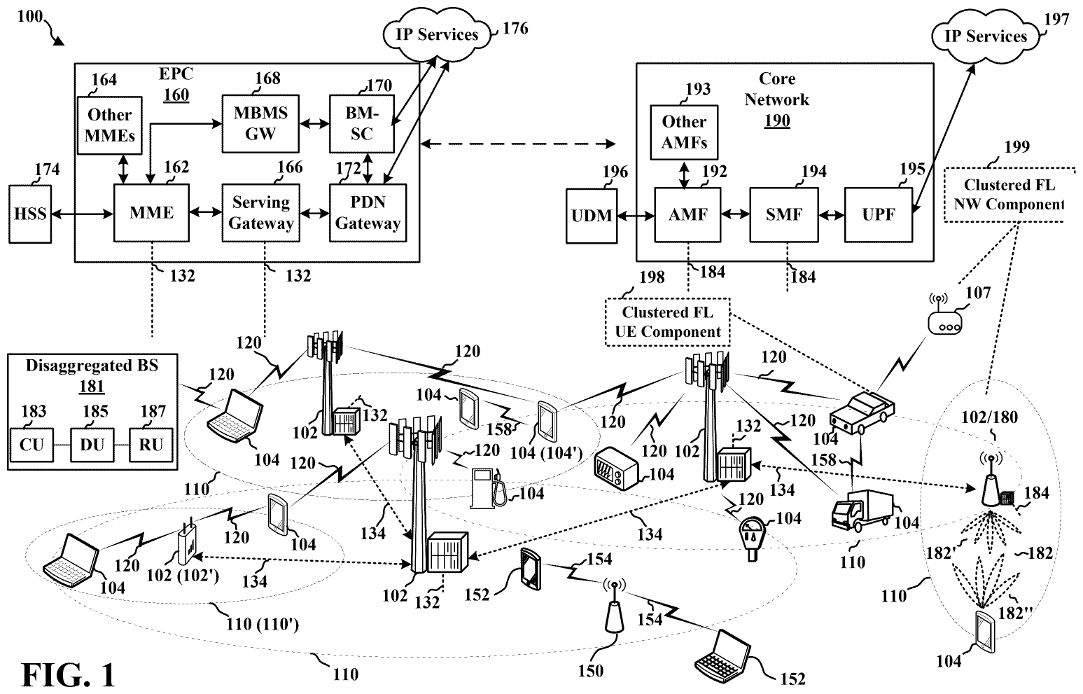

FIG. 1 is a diagram illustrating an example of a wireless communications system and an access network 100. The wireless communications system (also referred to as a wireless wide area network (WWAN)) includes base stations (BS) 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network (NW), a network node, a network entity, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

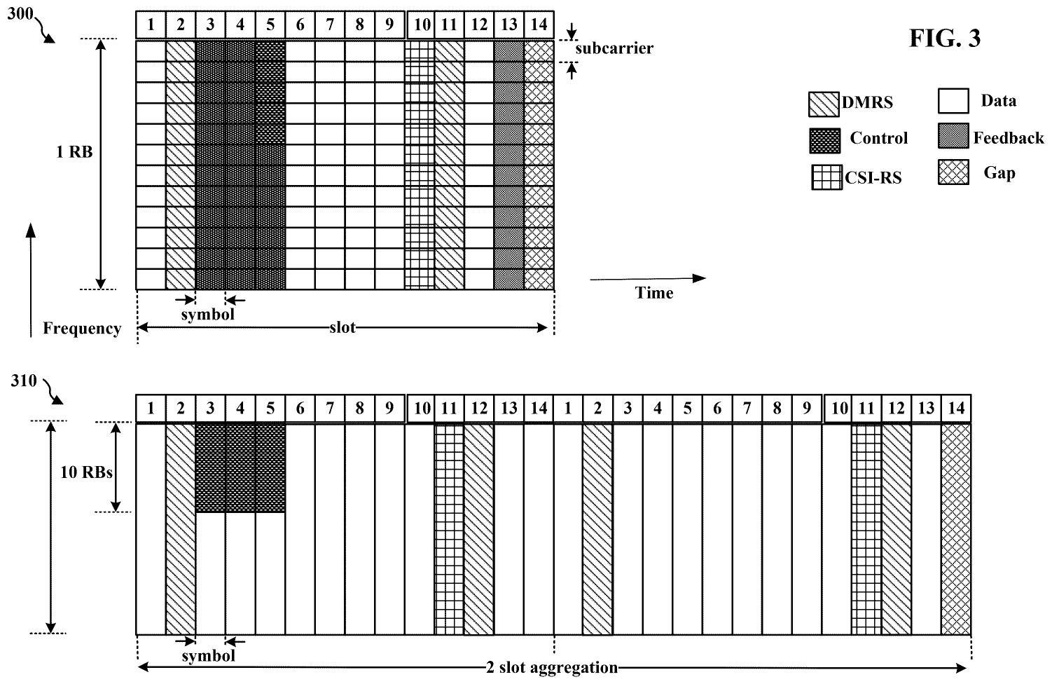

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication, e.g., as described in connection with the example in FIG. 3.

Referring again to FIG. 1, the UE 104 may include a clustered FL UE component 198. The clustered FL UE component 198 is configured to provide a first message including FL information, provide a second message indicating a first network node, and obtain a third message indicating one of the first network node or a second network node as an FL cluster leader and indicating an FL cluster of the UE in response to the FL information. The UE 104 including clustered FL UE component 198 may a transmitting device in uplink or sidelink communication such as a VUE, an IoT device, or other UE, or a receiving device in downlink or sidelink communication such as another VUE, another IoT device, or other UE. The first network node and the second network node may be RSUs 107, edge servers, or other nodes in communication with base station 102/180.

Still referring to FIG. 1, a first network node (e.g., the RSU 107 or the base station 102/180) may include a clustered FL NW component 199. The clustered FL NW component 199 is configured to obtain a first message including FL information of a second network node, and provide a second message indicating an FL cluster of the second network node in response to the FL information. The second message indicates one of the first network node or a third network node as an FL cluster leader of the FL cluster. The RSU 107 including clustered FL NW component 199 may a transmitting device in uplink or sidelink communication, or a receiving device in downlink or sidelink communication. The base station 102/180 including clustered FL NW component 199 may a transmitting device in downlink communication, or a receiving device in uplink communication. The second network node may be a UE (e.g., UE 104), and the third network node may be an RSU, edge server, or other node in communication with base station 102/180.

The concepts and various aspects described herein may be applicable to vehicle-to-everything (V2X) or other similar areas, such as D2D communication, IoT communication, Industrial (IIoT) IoT communication, and/or other standards/protocols for communication in wireless/access networks. Additionally or alternatively, the concepts and various aspects described herein may be applicable to vehicle-to-pedestrian (V2P) communication, pedestrian-to-vehicle (P2V) communication, vehicle-to-infrastructure (V2I) communication, and/or other frameworks/models for communication in wireless/access networks. Additionally, the concepts and various aspects described herein may be applicable to NR or other similar areas, such as LTE, LTE-Advanced (LTE-A), Code Division Multiple Access (CDMA), Global System for Mobile communications (GSM), or other wireless/radio access technologies. Additionally, the concepts and various aspects described herein may be applicable for use in aggregated or disaggregated base station architectures, such as Open-Radio Access Network (O-RAN) architectures.

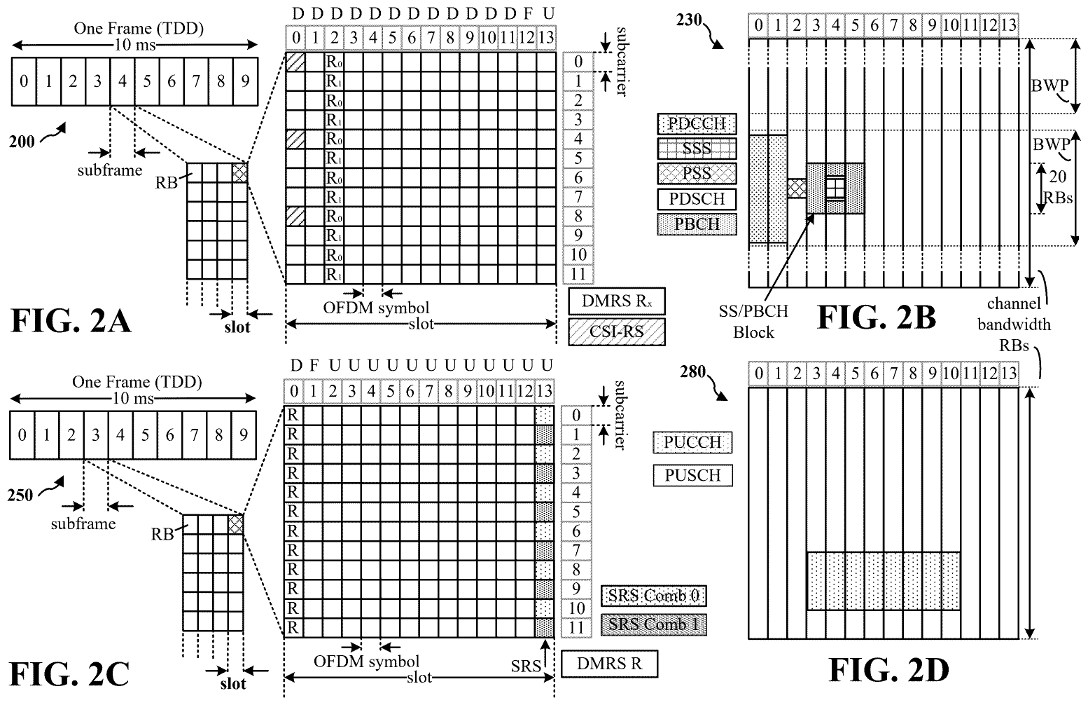

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

FIG. 3 illustrates example diagrams 300 and 310 illustrating example slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI). Diagram 310 illustrates an example two-slot aggregation, e.g., an aggregation of two 0.5 ms TTIs. Diagram 300 illustrates a single RB, whereas diagram 310 illustrates N RBs. In diagram 310, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may comprise control information, e.g., along with demodulation RS (DMRS). FIG. 3 also illustrates that symbol(s) may comprise CSI-RS. The symbols in FIG. 3 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. Multiple slots may be aggregated together. FIG. 3 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

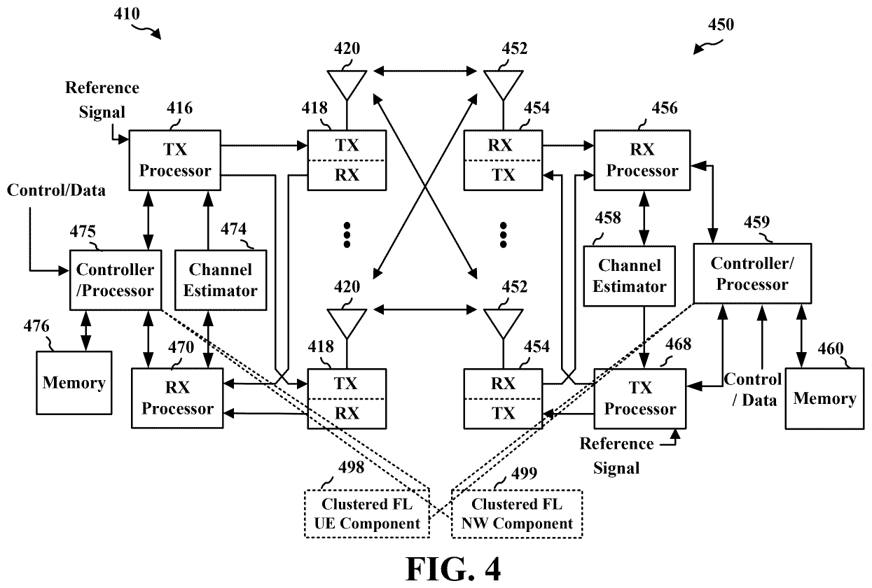

FIG. 4 is a block diagram of a first wireless communication device 410 in communication with a second wireless communication device 450, e.g., via V2V/V2X/D2D communication or in an access network. The device 410 may comprise a transmitting device communicating with a receiving device, e.g., device 450, via sidelink (e.g., V2V/V2X/D2D) communication or uplink/downlink communication. The transmitting device 410 may comprise a UE, a base station, an RSU, etc. The receiving device may comprise a UE, a base station, an RSU, etc.

IP packets from the EPC 160 may be provided to a controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418TX. Each transmitter 418TX may modulate an RF carrier with a respective spatial stream for transmission.

At the device 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the device 410. These soft decisions may be based on channel estimates computed by the channel estimator 458. The soft decisions are then decoded and deinterleaved to recover the data and control signals that were originally transmitted by the device 410 on the physical channel. The data and control signals are then provided to the controller/processor 459, which implements layer 3 and layer 2 functionality.

The controller/processor 459 can be associated with a memory 460 that stores program codes and data. The memory 460 may be referred to as a computer-readable medium. The controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the device 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The transmission is processed at the device 410 in a manner similar to that described in connection with the receiver function at the device 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing to recover IP packets from the device 450. IP packets from the controller/processor 475 may be provided to the EPC 160. The controller/processor 475 is also responsible for error detection using an ACK and/or NACK protocol to support HARQ operations.

At least one of the TX processor 416, 468, the RX processor 456, 470, and the controller/processor 459, 475 may be configured to perform aspects in connection with clustered FL UE component 198 of FIG. 1. For example, the controller/processor 459, 475 may include a clustered FL UE component 498 which is configured to provide a first message including FL information, provide a second message indicating a first network node, and obtain a third message indicating one of the first network node or a second network node as an FL cluster leader and indicating an FL cluster of the UE in response to the FL information.

In one example, the clustered FL UE component 498 of controller/processor 475 in device 410 may provide the first message to device 450 via TX processor 416, which may transmit the first message via antennas 420 to device 450. The clustered FL component 498 of controller/processor 475 in device 410 may provide the second message to device 450 via TX processor 416, which may transmit the second message via antennas 420 to device 450. The clustered FL component 498 of controller/processor 475 in device 410 may obtain the third message from device 450 via RX processor 470, which may obtain the third message from device 450 via antennas 420.

In another example, the clustered FL UE component 498 of controller/processor 459 in device 450 may provide the first message to device 410 via TX processor 468, which may transmit the first message via antennas 452 to device 410. The clustered FL component 498 of controller/processor 459 in device 450 may provide the second message to device 410 via TX processor 468, which may transmit the second message via antennas 452 to device 410. The clustered FL component 498 of controller/processor 459 in device 450 may obtain the third message from device 410 via RX processor 456, which may receive the third message from device 410 via antennas 452.

Moreover, at least one of the TX processor 416, 468, the RX processor 456, 470, and the controller/processor 459, 475 may be configured to perform aspects in connection with clustered FL NW component 199 of FIG. 1. For example, the controller/processor 459, 475 may include a clustered FL NW component 499 which is configured to obtain a first message including FL information of a second network node, and provide a second message indicating an FL cluster of the second network node in response to the FL information, where the second message indicates one of the first network node or a third network node as an FL cluster leader of the FL cluster. In one example, the clustered FL NW component 499 of controller/processor 475 in device 410 may obtain the first message from device 450 via RX processor 470, which may obtain the first message from device 450 via antennas 420. The clustered FL component 498 of controller/processor 475 in device 410 may provide the second message to device 450 via TX processor 416, which may transmit the second message via antennas 420 to device 450.

In another example, the clustered FL NW component 499 of controller/processor 459 in device 450 may obtain the first message from device 410 via RX processor 456, which may receive the first message from device 410 via antennas 452. The clustered FL NW component 499 of controller/processor 459 in device 450 may provide the second message to device 410 via TX processor 468, which may transmit the second message via antennas 452 to device 410.

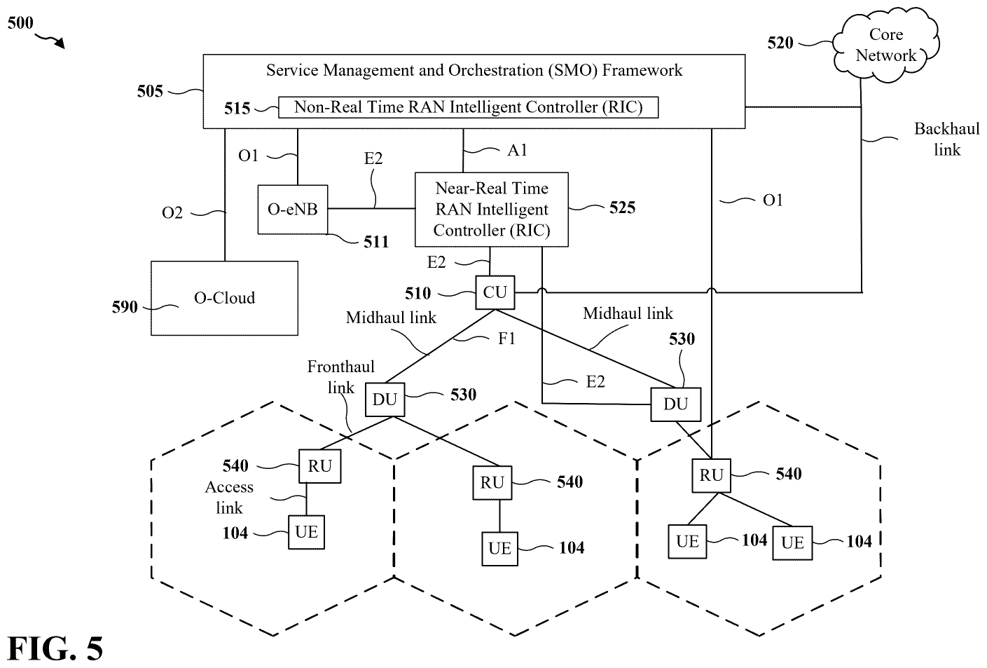

FIG. 5 shows a diagram illustrating an example disaggregated base station 500 architecture. The disaggregated base station 500 architecture may include one or more CUs 510 (e.g., CU 183 of FIG. 1) that can communicate directly with a core network 520 via a backhaul link, or indirectly with the core network 520 through one or more disaggregated base station units (such as a Near-Real Time RIC 525 via an E2 link, or a Non-Real Time RIC 515 associated with a Service Management and Orchestration (SMO) Framework 505, or both). A CU 510 may communicate with one or more DUs 530 (e.g., DU 185 of FIG. 1) via respective midhaul links, such as an F1 interface. The DUs 530 may communicate with one or more RUs 540 (e.g., RU 187 of FIG. 1) via respective fronthaul links. The RUs 540 may communicate respectively with UEs 104 via one or more radio frequency (RF) access links. In some implementations, the UE 104 may be simultaneously served by multiple RUs 540.

Each of the units, i.e., the CUs 510, the DUs 530, the RUs 540, as well as the Near-RT RICs 525, the Non-RT RICs 515 and the SMO Framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., Central Unit-User Plane (CU-UP)), control plane functionality (i.e., Central Unit-Control Plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the DU 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 120. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a vRAN architecture.

The SMO Framework 505 may be configured to support RAN deployment and provisioning of non-virtualized and virtualized network elements. For non-virtualized network elements, the SMO Framework 505 may be configured to support the deployment of dedicated physical resources for RAN coverage requirements, which may be managed via an operations and maintenance interface (such as an O1 interface). For virtualized network elements, the SMO Framework 505 may be configured to interact with a cloud computing platform (such as an open cloud (O-Cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and Near-RT RICs 525. In some implementations, the SMO Framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO Framework 505 also may include the Non-RT RIC 515 configured to support functionality of the SMO Framework 505.

The Non-RT RIC 515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 525. The Non-RT RIC 515 may be coupled to or communicate with (such as via an A1 interface) the Near-RT RIC 525. The Near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the Near-RT RIC 525.

In some implementations, to generate AI/ML models to be deployed in the Near-RT RIC 525, the Non-RT RIC 515 may receive parameters or external enrichment information from external servers. Such information may be utilized by the Near-RT RIC 525 and may be received at the SMO Framework 505 or the Non-RT RIC 515 from non-network data sources or from network functions. In some examples, the Non-RT RIC 515 or the Near-RT RIC 525 may be configured to tune RAN behavior or performance. For example, the Non-RT RIC 515 may monitor long-term trends and patterns for performance and employ AI/ML models to perform corrective actions through the SMO Framework 505 (such as reconfiguration via 01) or via creation of RAN management policies (such as A1 policies).

UEs 104, RSUs 107, base stations 102/180 including aggregated and disaggregated base stations 181, or other network nodes including at least the controller/processor 459, 475 of device 410, 450, may be configured to perform AI/ML tasks using artificial neural networks (ANNs). ANNs, or simply neural networks, are computational learning systems that use a network of functions to understand and translate a data input of one form into a desired output, usually in another form. Examples of ANNs include multilayer perceptrons (MLPs), convolutional neural networks (CNNs), deep neural networks (DNNs), deep convolutional networks (DCNs), and recurrent neural networks (RNNs), as well as other neural networks. Generally, ANNs include layered architectures in which the output of one layer of neurons is input to a second layer of neurons (via connections or synapses), the output of the second layer of neurons becomes an input to a third layer of neurons, and so forth. These neural networks may be trained to recognize a hierarchy of features and thus have increasingly been used in object recognition applications. For instance, neural networks may employ supervised learning tasks such as classification which incorporates a ML model such as logistic regression, support vector machines, boosting, or other classifiers to perform object detection and provide bounding boxes of a class or category in an image. Moreover, these multi-layered architectures may be fine-tuned using backpropagation or gradient descent to result in more accurate predictions.

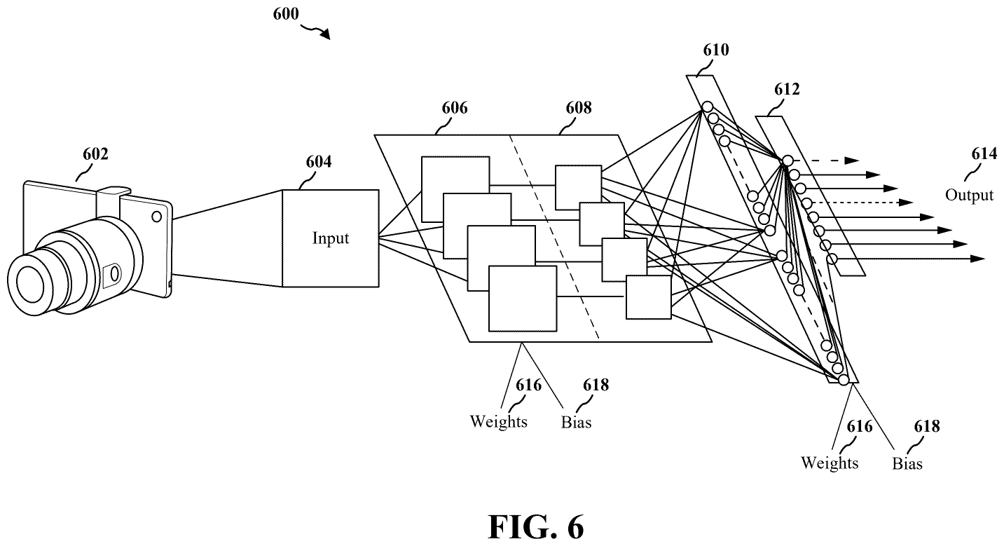

FIG. 6 illustrates an example of a neural network 600, specifically a CNN. The CNN may be designed to detect objects sensed from a camera 602, such as a vehicle-mounted camera, or other sensor. The neural network 600 may initially receive an input 604, for instance an image such as a speed limit sign having a size of 32×32 pixels (or other object or size). During a forward pass, the input image is initially passed through a convolutional layer 606 including multiple convolutional kernels (e.g., six kernels of size 5×5 pixels, or some other quantity or size) which slide over the image to detect basic patterns or features such as straight edges and corners. The images output from the convolutional layer 606 (e.g., six images of size 28×28 pixels, or some other quantity or size) are passed through an activation function such as a rectified linear unit (ReLU), and then as inputs into a subsampling layer 608 which scales down the size of the images for example by a factor of two (e.g., resulting in six images of size 14×14 pixels, or some other quantity or size). These downscaled images output from the subsampling layer 608 may similarly be passed through an activation function (e.g., ReLU or other function), and similarly as inputs through subsequent convolutional layers, subsampling layers, and activation functions (not shown) to detect more complex features and further scale down the image or kernel sizes. These outputs are eventually passed as inputs into a fully connected layer 610 in which each of the nodes output from the prior layer are connected to all of the neurons in the current layer. The output from this layer may similarly be passed through an activation function and potentially as inputs through one or more other fully connected layers (not shown). Afterwards, the outputs are passed as inputs into an output layer 612 which transforms the inputs into an output 614 such as a probability distribution (e.g., using a softmax function). The probability distribution may include a vector of confidence levels or probability estimates that the inputted image depicts a predicted feature, such as a sign or speed limit value (or other object).

During training, a ML model (e.g., a classifier) is initially created with weights 616 and bias(es) 618 respectively for different layers of neural network 600. For example, when inputs from a training image (or other source) enter a given layer of a MLP or CNN, a dot product of the inputs and weights, summed with the bias(es), may be transformed using an activation function before being passed to the next layer. The probability estimate resulting from the final output layer may then be applied in a loss function which measures the accuracy of the ANN, such as a cross-entropy loss function. Initially, the output of the loss function may be significantly large, indicating that the predicted values are far from the true or actual values. To reduce the value of the loss function and result in more accurate predictions, gradient descent may be applied.

In gradient descent, a gradient of the loss function may be calculated with respect to each weight of the ANN using backpropagation, with gradients being calculated for the last layer back through to the first layer of the neural network 600. Each weight may then be updated using the gradients to reduce the loss function with respect to that weight until a global minimization of the loss function is obtained, for example using stochastic gradient descent. For instance, after each weight adjustment, a subsequent iteration of the aforementioned training process may occur with the same or new training images, and if the loss function is still large (even though reduced), backpropagation may again be applied to identify the gradient of the loss function with respect to each weight. The weights may again be updated, and the process may continue to repeat until the differences between predicted values and actual values are minimized.

Network nodes such as UEs or base stations may train neural networks (e.g., neural network 600) using federated learning (FL). FL refers to a machine learning technique in which multiple decentralized nodes holding local data samples may train a global ML model (e.g., a classifier or other model applied by multiple network nodes) without exchanging the data samples themselves between nodes to perform the training. Thus, in contrast to centralized machine learning techniques where local data sets are typically all uploaded to one server, this approach allows for high quality ML models to be generated without the need for aggregating the distributed data. As a result, FL is convenient for parallel processing, significantly reduces costs associated with message exchanges, and preserves data privacy.

A FL framework includes multiple network nodes or entities, namely a centralized aggregation server and participating FL devices (i.e., participants or nodes such as UEs). The FL framework enables the FL devices to learn a global ML model by allowing for the passing of messages between the devices through the central aggregation server or coordinator, which may be configured to communicate with the various FL devices and coordinate the learning framework. For instance, the nodes may provide weights, biases, gradients, or other ML information to each other (other nodes) through messages exchanged between nodes via the central coordinator (e.g., a base station, RSU, an edge server, etc.).

Each node in a FL environment utilizes a dataset to locally train and update a coordinated global, ML model. The dataset may be a local data set that a node or device may obtain for a certain ML task (e.g., object detection, etc.). The data in a given dataset may be preloaded or may be accumulated throughout a device lifetime. For example, an accumulated dataset may include recorded data that a node observes and locally stores at the device from an on-board sensor such as a camera. The global ML model may be defined by its model architecture and model weights. An example of a model architecture is a neural network, such as the CNN described with respect to FIG. 6, which may include multiple hidden layers, multiple neurons per layer, and synapses connecting these neurons together. The model weights are applied to data passing through the individual layers of the ML model for processing by the individual neurons. Each node in the FL environment may process its own dataset and perform local updates to the global ML model, and the central server may aggregate the local updates and provide an updated global ML model to the nodes for further training or predictions.

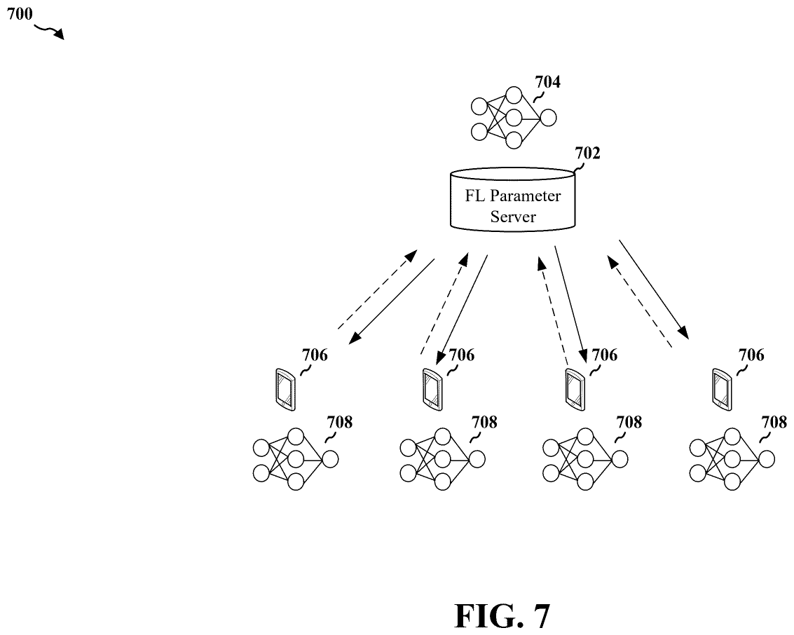

FIG. 7 illustrates an example 700 of a FL architecture. Initially, a FL parameter server 702 determines a task requirement and target application (e.g., detecting vehicles, pedestrians, or other objects for self-driving applications). Following this determination, the FL parameter server initializes a global ML model 704 (W₀^{G}) (e.g., a classifier in a pre-configured ML architecture such as the CNN of FIG. 6 with random or default ML weights) and broadcasts the global ML model 704 to participating devices or learning nodes 706 (e.g., UEs). Upon receipt of the global ML model at the learning nodes, an iterative process of FL may begin. For instance, upon receiving the global ML model 704 (Wₜ^{G}) at a given iteration t, the learning nodes 706 (k nodes) locally train their respective model 708 using their internal local dataset, which may be a preconfigured data set such as a training set and/or previously sensed data from the environment. After training, the learning nodes update their respective k-th model Wₜ^{k} (e.g., the local weights) until a minimization or optimization of a k-th loss function or cost function Fₖ (Wₜ^{k}) for that model is achieved. At this point, the learning nodes may have different local models Wₜ^{k} due to having different updated weights.

Afterwards, the learning nodes 706 transmit their local updated models Wk to the FL parameter server 702, which upon receipt aggregates the respective weights of the respective models 708 (e.g., by averaging the weights or performing some other calculation on the weights). The FL parameter server 702 may thus generate an updated global model Wₜ₊₁^{G} including the aggregated weights, after which the aforementioned process may repeat for subsequent iteration t+1. For instance, the FL parameter server 702 may broadcast the updated global model Wₜ₊₁^{G} to the learning nodes 706 to again perform training and local updates based on the same dataset or a different local dataset, after which the nodes may again share their respectively updated models to the FL parameter server for subsequent aggregation and global model update. This process may continue to repeat in further iterations and result in further updates to the global model Wₜ^{G} until a minimization of a loss function F_{G} (Wₜ^{G}) for the global model is obtained, or until a predetermined quantity of iterations has been reached.

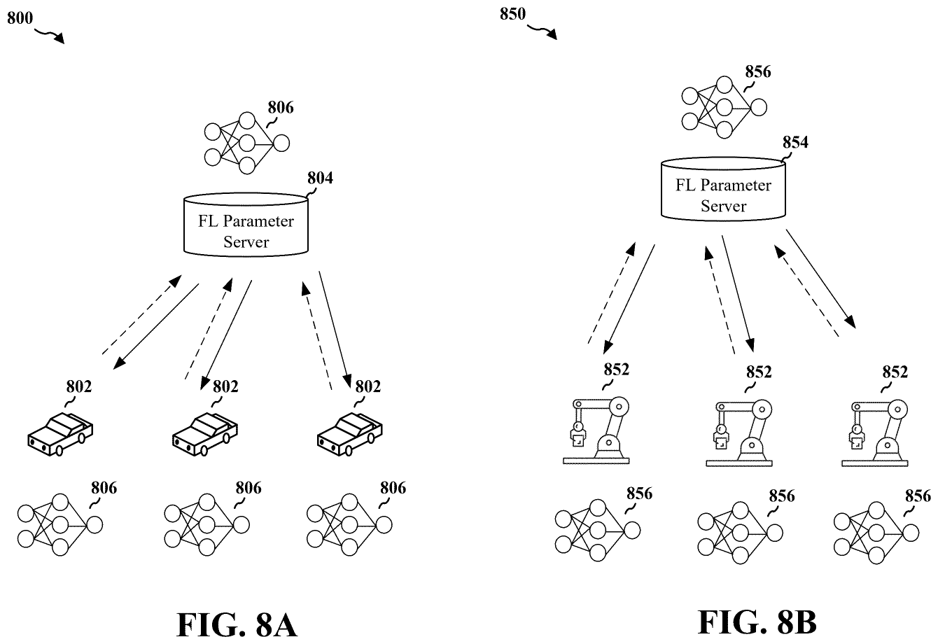

FIGS. 8A and 8B illustrate examples 800, 850 of different applications associated with wireless connected devices that may benefit from FL, including connected vehicles for autonomous driving (FIG. 8A) and mobile robots for manufacturing (FIG. 8B). For instance, in the example 800 of FIG. 8A, network nodes 802 (e.g., VUEs such as learning nodes 706 in FIG. 7) equipped with vision sensors such as cameras, light detection and ranging (LIDAR), or radio detection and ranging (RADAR), may communicate with a FL parameter server 804 (e.g., a base station or an RSU) to collaboratively train and enhance the accuracy of a neural network 806 for detecting objects and object bounding boxes (OBBs) in connection with autonomous driving. Similarly, in the example 850 of FIG. 8B, network nodes 852 (e.g., mobile robot UEs such as learning nodes 706 in FIG. 7) equipped with inertial measurement units (IMUs), RADAR, camera, or other sensors in a manufacturing environment may communicate with a FL parameter server 854 (e.g., a base station) in mmW frequencies to collaboratively train a neural network 856 associated with a manufacturing-related task.

However, conventional FL architectures rely on a centralized server (e.g., FL parameter server 702, 804, 854) to create, aggregate, and refine a global ML model for participating nodes, thus necessitating the transmission of locally trained ML models from participating nodes to the server during an FL iteration. This centralized approach to FL may have various drawbacks or limits. In one example, since the centralized server is the sole aggregator for the participating nodes, the centralized server may serve as a single point of failure for the FL system. As a result, if the centralized server ceases to operate at any time, a bottleneck could arise in the entire FL process. In another example, since a participant sends its local model updates to the centralized server, significant communication overhead may arise in applications where the volume of ML model information outweighs the raw data itself. In further examples, statistical challenges in model training may arise due to the heterogeneity of computational resources existing for different participants, the heterogeneity of training data available to participants, and the heterogeneity of training tasks and associated models configured for different participants. In another example, even though raw data is not directly communicated between nodes in FL, security and privacy concerns may still arise from the exchange of ML model parameters (e.g. due to leakage of information about underlying data samples).

To address these limits associated with conventional FL architectures, a clustered or hierarchical approach to FL may be applied in which learning nodes working towards a common learning task are grouped together into clusters. In clustered FL, multiple clusters may be formed from respective groups of learning nodes (e.g., UEs) having a local dataset and sharing a common ML task such as object detection or classification (e.g., detecting an OBB, a vehicle or pedestrian on a road, etc.). In one example, a FL parameter server (e.g., a base station) may group network nodes (e.g., UEs) together into clusters led by designated cluster leaders (e.g., road side units, edge servers, or other network nodes). In another example, a network node (e.g., a road side unit) may itself form and lead a cluster with other network nodes (e.g., UEs), without base station involvement. In either example, the cluster formation and leader selection are network-assisted (e.g., via messages circulated within the network identifying clusters and confirming cluster leaders).

Moreover, in contrast to conventional FL, in hierarchical FL the designated cluster leader for each cluster, rather than the FL parameter server directly, coordinates the learning task including local ML model training and updates within that cluster. This coordination is referred to as intra-cluster FL. For instance, individual nodes within a cluster may pass messages including local updates to ML model weights to a cluster leader (e.g., a RSU, edge server, or other network node designated with an identifier as the leader of that cluster) to aggregate and send the updated local model back to the individual nodes within that cluster. After clusters are formed, the centralized FL parameter server (e.g., a base station) may coordinate the learning task including global ML model training and updates between clusters. This coordination is referred to as inter-cluster FL. For instance, individual cluster leaders of respective clusters may pass messages including aggregated local updates to ML model weights to the FL parameter server to aggregate and send the updated global ML model back to the individual cluster leaders, which in turn, will pass the updated global model to their respective cluster members to further train and update. The cluster leaders may thus act as intermediaries between the learning nodes and the FL parameter server for coordinating neural network training and optimization between different clusters.

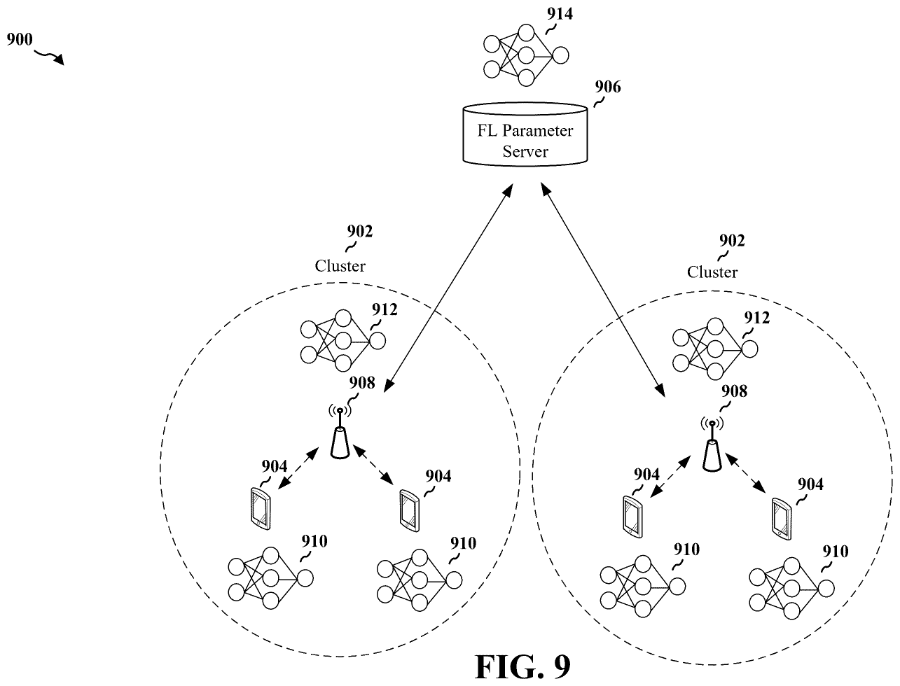

FIG. 9 illustrates an example 900 of a clustered FL architecture including clusters 902 of UEs 904 (e.g., vehicle UEs, pedestrian UEs, etc.) in communication with an FL parameter server 906 (e.g., a base station, a RSU, an edge server, or other network entity). UEs 904 sharing common learning tasks, models, datasets, or computational resources may be grouped into one or more clusters, and multiple clusters 902 of such UEs may be formed. A cluster leader 908 may be designated for a cluster with network assistance. For example, the FL parameter server 906 (e.g., a base station) may designate an RSU, edge server, or other network entity as cluster leader 908 for a given cluster if that network entity is in communication with UEs 904 of that respective cluster, as well as designate the UEs 904 participating in respective clusters.

UEs 904 in a given cluster may conduct a similar training process to that of the conventional FL process described with respect to FIG. 7, except that the cluster leader 908 serve as an aggregator for its respective clusters rather than the FL parameter server, and model training occurs at multiple levels (intra-cluster and inter-cluster). For instance, the cluster leader 908 of a given cluster may groupcast an initialized ML model to the UEs 904 within the cluster 902 to perform local training, which UEs in turn send their individually updated ML models 910 back to the cluster leader 908 to aggregate into an updated local model 912 for that cluster. The cluster leader 908 may then groupcast the updated local model 912 to the UEs 904 to again perform local training in a next iteration and this intra-cluster process may repeat in further iterations. Additionally, at certain times or in response to certain events, the cluster leaders 908 may communicate their respective, updated local models to the FL parameter server 906 to aggregate into an updated global model 914 for the clusters. The FL parameter server 906 may then send these aggregated global models back to the cluster leaders 908 to be circulated within their respective clusters 902. Thus, unlike conventional FL where learning nodes communicate directly with the FL parameter server for model optimization, here the cluster leaders communicate directly with the FL parameter server, and the learning nodes within a cluster instead communicate directly with the cluster leader. As a result, neural network training may be achieved in a distributed manner using clustered FL with minimal bottlenecks, minimal communication overhead, minimal challenges to model training due to heterogeneity of computational resources, training data, training tasks, or associated ML models, and minimal security and privacy challenges that may arise in conventional FL.

Various examples of signaling procedures between network nodes (e.g. a UE, road side unit, and base station) are provided in order to implement clustered FL. In one example, a signaling procedure for cluster formation and leader selection is provided in which nodes participating in the ML training tasks are grouped together into clusters with other nodes (with network involvement) led by selected cluster leaders (ML model weight aggregators) for respective clusters based on configured criteria. In another example, a signaling procedure for cluster formation and leader selection is provided in which nodes participating in the ML training tasks may join clusters led by other nodes in response to respective requests from the other nodes. In a further example, upon completion of cluster formation and leader selection, a signaling procedure for clustered FL training may be provided in which nodes may perform intra-FL training coordinated by a cluster leader within a respective cluster through message passing between learning nodes and the cluster leader. In a further example, upon completion of cluster formation and leader selection, a signaling procedure for clustered FL training may be provided in which nodes may perform inter-FL training coordinated by an FL parameter server across different clusters through message exchanges between respective cluster leaders and the FL parameter server. The foregoing examples of signaling procedures may apply downlink/uplink communication (over a Uu interface) between UEs and a network entity such as a base station or road side unit.

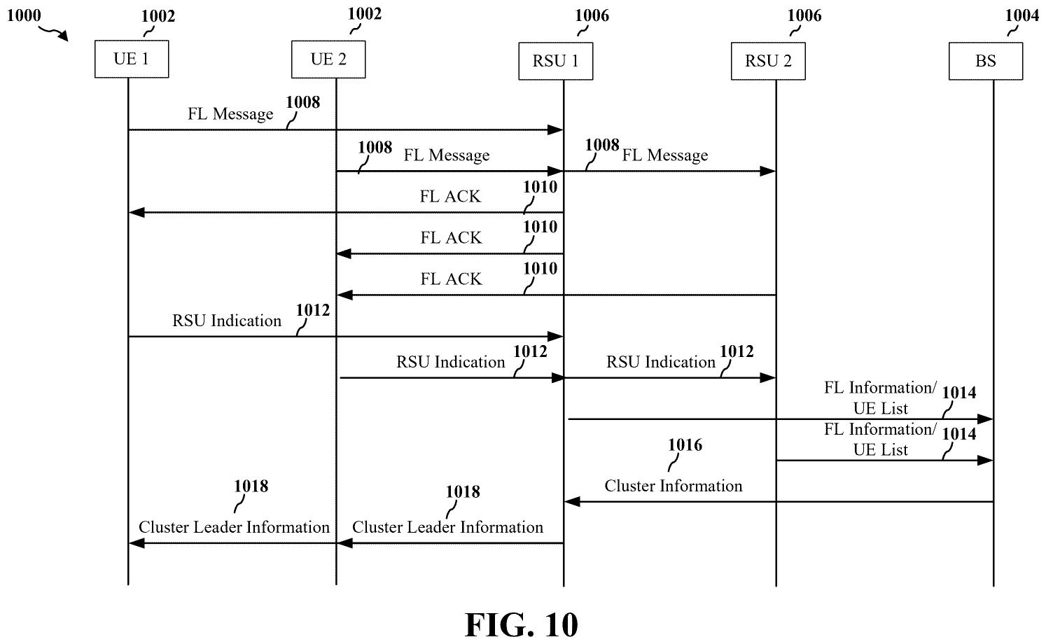

FIG. 10 illustrates an example 1000 of a signaling procedure which allows UEs 1002 to form a cluster (e.g., cluster 902 in FIG. 9) and a base station 1004 to select an RSU 1006 as a cluster leader or model weight aggregator for the UEs 1002 and other FL participants within the cluster. In this procedure, the base station 1004 may form clusters of UEs 1002 based on FL information (e.g., ML model-related information) of these respective UEs, and the base station may designate RSUs which are capable of communication with these UEs as respective cluster leaders. For example, the base station 1004 may select one of multiple RSUs to serve as a model weight aggregator for a group of UEs in communication with the RSU and indicated by the RSU as having an interest in performing a same ML task in FL, having same or similar sensors and input formats for training data in FL, having same or similar quantities of available computational resources for FL, or other parameters. Thus, the base station may cluster UEs having similar FL parameters for maximum efficiency in model training and optimization (e.g., by not grouping UEs together with different ML tasks, different computational capabilities, etc.), as well as select an RSU for cluster leadership that is capable of communication with these UEs for coordinating the model training and optimization. While the illustrated example of FIG. 10 specifically refers to RSUs 1006 as cluster leaders or model weight aggregators, in other examples, edge servers or other network nodes may replace the RSUs as cluster leaders or model weight aggregators. For instance, RSUs may be applied in a vehicle-related application of FL such as illustrated in FIG. 8A, while edge servers may be applied in a manufacturing-related application of FL such as illustrated in FIG. 8B.

Initially, UEs 1002 may respectively transmit an FL message 1008. The FL message 1008 is intended to be received by RSUs 1006, which in this example are prospective cluster leaders. At the time the FL messages 1008 are transmitted, the RSUs are not aware of the UEs 1002 with which the RSUs can respectively communicate (e.g., which UEs are neighbors or proximal to a respective RSU), nor the ML task(s) that these UEs are interested in performing. Thus, the FL messages 1008 may serve as discovery messages in response to which UEs and RSUs may become aware of the other's presence.

The FL message 1008 may be provided periodically (e.g., with a pre-configured periodicity), or in response to an event. In one example of an event, a UE may be triggered to send the FL message 1008 upon entering a service coverage area of an RSU or base station. In another example of an event, the UE may be triggered to send the FL message 1008 in response to a decision by the UE to join an FL cluster to improve the accuracy of its ML model. For instance, the UE may provide FL message 1008 if its classification accuracy or other evaluation metric falls below a threshold.

The FL message 1008 further indicates FL or model training-related information of a respective UE. This information may include, for example, ML tasks that the UE is participating in or is interested in participating in, available sensors at the UE and their associated data input format, available ML models in training including model status, model architectures, model training parameters, and current performance (e.g., accuracy and loss), and available computation resources (e.g., whether the UE includes a CPU or GPU, information about its clock speed, available memory, etc.). For instance, the FL message 1008 may indicate that the UE is configured to perform object detection (e.g., to identify OBBs), image classification, reinforcement learning, or other ML task. The FL message 1008 may indicate that the UE includes a camera, LIDAR, RADAR, IMU, or other sensor, and data format(s) that are readable by the indicated sensor(s). The FL message 1008 may indicate that the UE is configured with a neural network (e.g., the CNN of FIG. 6, a DNN, a DCN, a RNN, or other ANN), a quantity of neurons and synapses, a logistic regression or classification model, current values for model weights and biases, an applied activation function (e.g., ReLU), a classification accuracy, and a loss function applied for model weight updates (e.g., a cross-entropy loss function). The FL message 1008 may indicate that a CPU or GPU of the UE (e.g., controller/processor 459 or some other processor of device 450) applies the indicated neural network(s) and model(s) for the indicated ML task(s), a clock speed of the CPU or GPU, and a quantity of available memory (e.g., memory 460 or some other memory of device 450) for storing information associated with the ML task, neural network, data, etc. The FL message 1008 may include any combination of the foregoing, as well as other information.

The FL message 1008 may be broadcast in order to solicit a response from any RSU capable of decoding the FL message. For instance, in the illustrated example of FIG. 10, RSU 1 may be proximal to (e.g., a neighbor of) both UE 1 and UE 2 and thus successfully decode the FL messages of both UE 1 and UE 2, while RSU 2 may be proximal to UE 2 and thus successfully decode the FL message of UE 2. Thus, one UE may provide an FL message to multiple RSUs, and one RSU may obtain an FL message respectively from multiple UEs.

In response to receiving and decoding the FL message 1008 from a respective UE, an RSU (e.g., RSU 1 or RSU 2) may store the identifier of the UE in memory, store (at least temporarily) the FL information of the UE 1002 in memory, and provide the UE 1002 a FL message acknowledgment 1010 confirming receipt of its FL message. The RSU 1006 may provide the FL message acknowledgment 1010 via unicast to the respective UE. The FL message acknowledgment 1010 may also indicate an identifier of the RSU 1006 so that the UE 1002 receiving the acknowledgment may ascertain the source RSU. For example, if the UE 1002 provided the FL message 1008 to multiple RSUs 1006, the UE will obtain multiple such FL message acknowledgments 1010 including respective identifiers from the respective RSUs. For instance, in the illustrated example of FIG. 10, UE 2 may provide its FL message to both RSU 1 and RSU 2, and therefore UE 2 may obtain an FL message acknowledgment from RSU 1 indicating an identifier of RSU 1 and an FL message acknowledgment from RSU 2 indicating an identifier of RSU 2. Similarly, UE 1 also provided its FL message to RSU 1, and therefore UE 1 may similarly obtain an FL message acknowledgment from RSU 1 indicating an identifier of RSU 1 (but not an acknowledgment from RSU 2, since RSU 2 did not obtain or successfully decode the FL message).

After obtaining the FL message acknowledgement(s) from respective RSU(s) 1006, a UE may ascertain the RSUs in the network which have decoded its FL message. The UE may then select one of these acknowledging RSU(s) to act as its delegate for passing its FL information to the base station 1004 for cluster formation and leader selection. Similarly, other UEs may select a respective acknowledging RSU to act as their respective delegates for passing respective FL information. For instance, in the illustrated example of FIG. 10, UE 1 may select only RSU 1 given its sole acknowledgement of the FL message 1008 from that UE, while UE 2 may select either RSU 1 or RSU 2 given both RSU's acknowledgment of the FL message 1008 from that UE. However, if UE 2 happens to also select RSU 1 in this example, then RSU 1 would end up inefficiently sending the FL information of both UEs to the base station, incurring additional communication overhead at RSU 1 than in the case where RSU 2 happened to be selected. Therefore, to minimize the communication overhead between the RSUs 1006 and the base station 1004, UEs 1002 may be configured to select different RSUs for the FL message passing. For instance, in the aforementioned example, UE 2 may be configured to select RSU 2 in this situation (rather than RSU 1). As a result, inefficient situations may be avoided of an RSU passing to the base station FL information from multiple UEs, or multiple RSUs passing to the base station FL information of a single UE.

After selecting an RSU from the acknowledging RSU(s), the UE 1002 may provide an RSU indication message 1012 including the identifier of the selected RSU to the acknowledging RSU(s). In the case of multiple acknowledging RSUs (e.g., RSU 1 and RSU 2 for UE 2 in the example of FIG. 10), the UE may provide the RSU indication message 1012 via groupcast to the multiple acknowledging RSUs. The message is provided via groupcast to allow the acknowledging RSUs to respectively determine whether or not the RSU was indicated as a delegate for FL message passing by that UE. Upon receiving the RSU indication message 1012 from a respective UE, an RSU having an identifier that matches the identifier included in the RSU indication message 1012 may determine itself to be a delegate for passing FL information of that UE, and therefore maintain its storage in memory of the FL information in the FL message 1008 from that UE. In contrast, an RSU having an identifier that does not match the identifier included in the RSU indication message 1012 may determine itself to not be a delegate for that UE, and therefore may drop or discard the FL information of that UE from memory while still maintaining its storage in memory of the identifier of the UE. Notwithstanding the indicated RSU in the RSU indication message 1012, an RSU may continue to store identifiers of UEs which the RSU previously acknowledged in order to track its ability to communicate with those UEs and to inform the base station 1004 of this list of UEs during cluster formation and leader selection.

In response to obtaining the RSU indication message(s) 1012 from the UEs 1002, the RSUs 1006 may respectively provide a message 1014 to base station 1004 including the FL information of the UE which indicated the RSU's identifier and a list (or other data structure) of the identifiers of the UEs 1002 which the RSU has previously acknowledged (and thus has the ability to communicate). For instance, in the illustrated example of FIG. 10, RSU 1 may provide the FL information of UE 1 to base station 1004, RSU 2 may provide the FL information of UE 2 to base station 1004, and both RSU 1 and RSU 2 may provide the identifiers of UE 1 and UE 2 to base station 1004. As a result, the base station 1004 may be informed of the ML tasks, sensors, model information, and computational capabilities of the UEs 1002, and the RSUs 1006 which may communicate with respective UEs.

In one example, one or more of the RSUs 1006 may be learning nodes, rather than merely UE FL information aggregators. For instance, these RSU(s) may have obtained their own local dataset and intend to train their own ML model using that dataset in FL. In such case, those RSU(s) 1006 may also provide in message 1014 their own FL information to the base station 1004, similar to the FL information of the UEs. This information may include, for example, ML tasks that the RSU is participating in or is interested in participating in, available ML models in training including model status, model architectures, model training parameters, and current performance (e.g., accuracy and loss), and available computation resources (e.g., whether the RSU includes a CPU or GPU, information about its clock speed, available memory, etc.). While in one example the message 1014 from an RSU may include the UE FL information, UE list, and RSU FL information if existing, in other examples, any combination of the foregoing may be included in one or multiple such messages 1014 from an RSU.

In response to receiving the messages 1014 from respective RSUs 1006, the base station 1004 may aggregate the UE FL information (e.g., store in memory the FL information of the respective UEs 1002), select the RSU(s) serving as cluster leaders based on the aggregated information, and select the UEs 1002 to be members or participants of the clusters led by respectively selected RSU(s) based on the aggregated information. For instance, the base station may assign UEs 1002 to a cluster of an RSU which indicated a capability to communicate with those UEs in message 1014 (e.g., via inclusion of those UEs' identifiers). The base station may not necessarily assign a UE to the cluster of the same RSU which identifier the UE indicated in the RSU indication message 1012. For instance, in the illustrated example of FIG. 10, even though the base station 1004 obtained messages 1014 from both RSU 1 and RSU 2 respectively indicating the FL information of UE 1 and UE 2 (in response to UE 1 and UE 2 respectively indicating RSU 1 and RSU 2 as their delegates in respective RSU indication messages 1012), the base station may assign both UE 1 and UE 2 as cluster members of a cluster led by RSU 1.

The base station 1004 may also select an RSU to serve as a cluster leader and the UEs to serve as cluster members of such RSU based on other factors than the communication capability indicated in the messages 1014. For instance, the base station may select as cluster leader whichever RSU can communicate with the largest quantity of UEs (e.g., the RSU whose list included the largest quantity of UE identifiers), and group those UEs together in a cluster under that RSU. For example, in the illustrated example of FIG. 10, the base station may select RSU 1 as the cluster leader of both UE 1 and UE 2, rather than RSU 1 as the cluster leader of UE 1 and RSU 2 as the cluster leader of UE 2, in response to determining from the obtained lists of UEs in messages 1014 that RSU 1 may communicate with the larger quantity of UEs (e.g., both UE 1 and UE 2) as opposed to RSU 2 (which may only communicate with UE 1 in this example). Additionally or alternatively, the base station may select UEs 1002 having same or similar computational capabilities to be in a same cluster, while selecting UEs having different computational capabilities to be in different clusters. For instance, in the illustrated example of FIG. 10, the base station 1004 may group UE 1 and UE 2 in a same cluster led by RSU 1 in response to determining from the FL information in messages 1014 that UE 1 and UE 2 both have high computational capabilities or both have low computational capabilities. In contrast, if UE 1 had high computational capabilities and UE 2 had low computational capabilities, or vice-versa, the base station 1004 may determine to group UE 1 and UE 2 in different clusters led by different RSUs (e.g., to avoid the low capability UE from acting as a bottleneck in model training via FL for the high capability UE). Additionally or alternatively, in other examples, the base station may apply other criteria in its selection of cluster leaders and cluster members based on the FL information in messages 1014.

Following this aggregation and selection, the base station 1004 may provide a message 1016 respectively to selected RSU(s) via unicast indicating their respective cluster information. The cluster information provided to a respective RSU may include, for example, the identifiers of the UEs which will be grouped into a cluster for FL that is led by that RSU. For instance, in the illustrated example of FIG. 10, the base station 1004 may inform RSU 1 of its status as the cluster leader or model update aggregator of a cluster including UE 1 and UE 2. For example, the base station 1004 may provide to RSU 1 the identifiers of UE 1 and UE 2. If the base station does not select a particular RSU as a cluster leader or aggregator, the base station may not provide such message or cluster information to that RSU. For instance, in the illustrated example of FIG. 10, the base station may not select RSU 2 as a cluster leader, and thus the base station may not provide message 1016 to RSU 2.

Upon obtaining respective cluster information in message(s) 1016 from the base station 1004, the RSU(s) 1006 which received such information may respectively provide a message 1018 to the UEs 1002 indicated in their respective cluster information. An RSU may provide its respective message 1018 via groupcast to those UEs 1002 having identifiers assigned or indicated in the cluster information of message 1016. The message 1018 may inform these UEs 1002 of their status as participant or follower nodes for FL in a cluster led by that RSU, and may instruct those UEs to provide ML model weight updates to that RSU for training and optimization during clustered FL. For instance, in the illustrated example of FIG. 10, RSU 1 may provide message 1018 via groupcast to UE 1 and UE 2 indicating those UEs are cluster members of a cluster led by RSU 1.

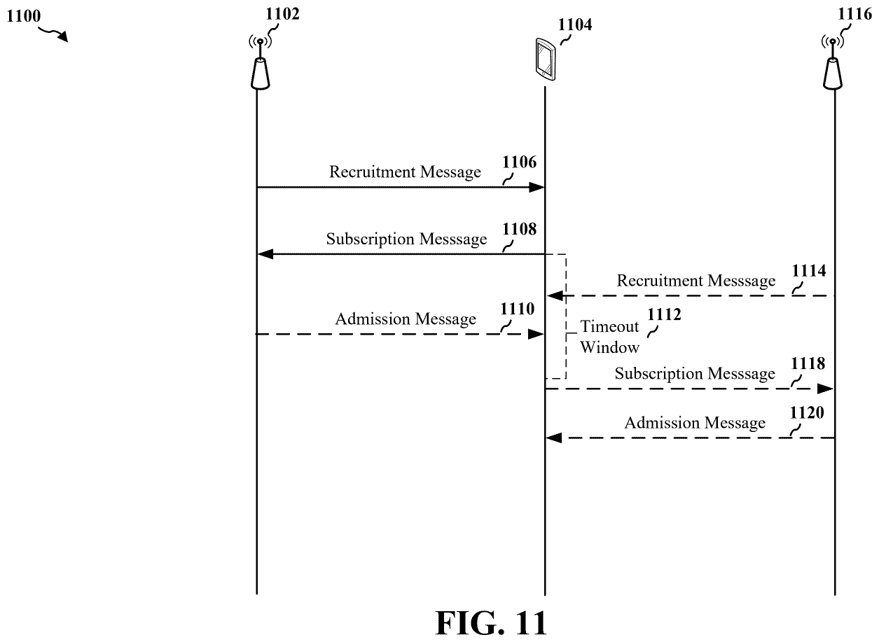

FIG. 11 illustrates an example 1100 of a signaling procedure which allows a first node 1102 (e.g. a RSU) to form a cluster (as cluster leader in a clustered FL architecture) with a second node 1104 (e.g., a UE), e.g., in sidelink communications. In this procedure, network nodes (e.g., RSUs) may nominate themselves as cluster leaders, rather than be selected as cluster leaders by other network nodes (e.g., a base station). Moreover, a network node intending to serve as a leader may form a cluster with other network nodes by sending a message to recruit these other nodes to its cluster. This recruitment message may indicate that the network node intends to operate as a cluster leader and FL coordinator as well as indicate ML training-related information of the network node.

Nodes which receive this recruitment message, and potentially other recruitment messages from other self-nominated leaders, may determine whether or not to subscribe to any of the indicated clusters led by the respective senders based on the indicated ML training-related information in the respective messages. If a network node determines to subscribe to a cluster of one of these sending nodes, the network node may send back a message requesting to subscribe to this cluster and further indicating ML-related training information of this node; otherwise, the network node may ignore the recruitment message. The recruiting node upon receipt of the subscription message may decide whether or not to admit the subscribing node to its cluster similarly based on the indicated ML-related training information of the subscribing node. If an admission decision is made, the recruiting node may send an acknowledgment of cluster admission to the subscribing node. Otherwise, the recruiting node may ignore the subscription message, and the subscribing node may search to join a different cluster after a specified period of time.

Initially, the first node 1102 transmits a message 1106 indicating the first node 1102 is interested in recruiting other nodes to form or join a cluster led by the first node. The message 1106 may be provided periodically (e.g., according to a pre-configured periodicity), for example, if the first node is not currently participating in an active clustered FL session. Alternatively, the message 1106 may be event-triggered, for example, in response to the first node 1102 determining to train or update a ML model of a UE to improve performance of a certain ML task by that UE. The first node 1102 may broadcast the message 1106 to any network node which is capable of decoding the message. Alternatively, the message 1106 may be groupcast, for example, to network nodes of which the first node 1102 is aware. The message 1106 may also be sent using groupcast option 1 to enhance reliability of the recruitment message (e.g., the first node 1102 may indicate in second stage SCI a distance within which the first node expects to receive NACKs from other nodes who fail to decode the message). Moreover, the message 1106 may indicate model training-related information of the first node 1102. This information may include, for example, ML tasks that the first node 1102 is participating in or is interested in participating in, available ML models in training including model status, model architectures, model training parameters, and current performance (e.g., accuracy and loss), and available computation resources (e.g., whether the first node 1102 includes a CPU or GPU, information about its clock speed, available memory, etc.). Thus, the message 1106 may include similar types of information as those provided in the message 1014 of FIG. 10.

In the example of FIG. 11, second node 1104 may receive the message 1106 from the first node 1102 if the nodes are within proximity of each other. The second node 1104 may potentially receive other such messages from other network nodes requesting to recruit the second node to a cluster led by that respective node. Thus, the second node 1104 may receive recruitment messages from multiple candidates for cluster leadership. In response to receiving the recruitment message(s), the second node may determine whether to subscribe to a cluster of one of these candidates, based at least in part on the model training-related information indicated in the respective messages. This determination may be based on the model training-related information in the message 1106, including factors such as whether the candidate node and the second node have similar ML models, computational resources, etc.). For example, the second node 1104 may decide not to subscribe to a cluster of the first node 1102 if this information indicates the first node has a dissimilar ML model or a lower computation capability than that of the second node (e.g., if the RSU is configured with a Markov model or a small amount of available memory for ML while the UE is configured with a classification model or a high amount of available memory for ML). Alternatively, the second node 1104 may decide to subscribe to the cluster of the first node 1102 if the information indicates, for example, that the first node has a same or similar ML model (e.g., a classification model) or a same or similar computation capability (e.g., memory) as that of the second node.

In this example, the second node 1104 determines to form or join a cluster led by the first node 1102, and so the second node may provide a message 1108 to the first node 1102 (e.g., via unicast) requesting to subscribe to or join with its cluster. This message 1108 may also indicate model training-related information of the second node 1104. This information may include, for example, ML tasks that the second node 1104 is participating in or is interested in participating in, available sensors at the second node and their associated data input format, available ML models in training including model status, model architectures, model training parameters, and current performance (e.g., accuracy and loss), and available computation resources (e.g., whether the second node includes a CPU or GPU, information about its clock speed, available memory, etc.). Thus, the message 1108 may include the same type of information as message 1106, but for the second node 1104 rather than the first node 1102.

In response to receiving the message 1108, the first node 1102 may determine whether or not to admit the second node 1104 to its cluster similarly based at least in part on the model training-related information indicated in the message 1108. For example, the first node 1102 may decide not to add the second node 1104 to its cluster if this information indicates the second node has a dissimilar ML model or a lower computation capability than that of the first node. In such case, the first node 1102 may disregard or ignore (and thus not respond to) message 1108. Alternatively, the first node 1102 may decide to add the second node 1104 to its cluster if the information indicates, for example, that the nodes have a same or similar ML model or a same or similar computation capability. In such case, the first node 1102 may provide (e.g., via unicast) a message 1110 acknowledging admission of the second node 1104 to the cluster led by the first node 1102.

On the other hand, if the first node 1102 decides not to admit the second node 1104 to its cluster, the second node may fail to receive message 1110 within a timeout window 1112 starting from the time that message 1108 was provided (due to the first node disregarding or ignoring message 1108). In such case, the second node 1104 may subscribe to the cluster of another network node from which the second node previously received a recruitment request. For instance, in the illustrated example of FIG. 11, the second node 1104 may have previously received a message 1114 from a third node 1116 (e.g., another RSU) requesting to recruit other nodes to its cluster (similar to message 1106), and based at least in part on model training-related information of the third node 1116 indicated in the message 1114, the second node 1104 may transmit a message 1118 requesting to subscribe to or join the cluster led by the third node 1116 upon expiration of the timeout window 1112. In response to receiving the message 1118, the third node 1116 may similarly determine whether to admit the second node 1104 to its cluster based at least in part on the model training-related information indicated in the message 1118, in which case the third node 1116 may provide (e.g., via unicast) a message 1120 acknowledging admission of the second node 1104 to the cluster led by the third node 1116.

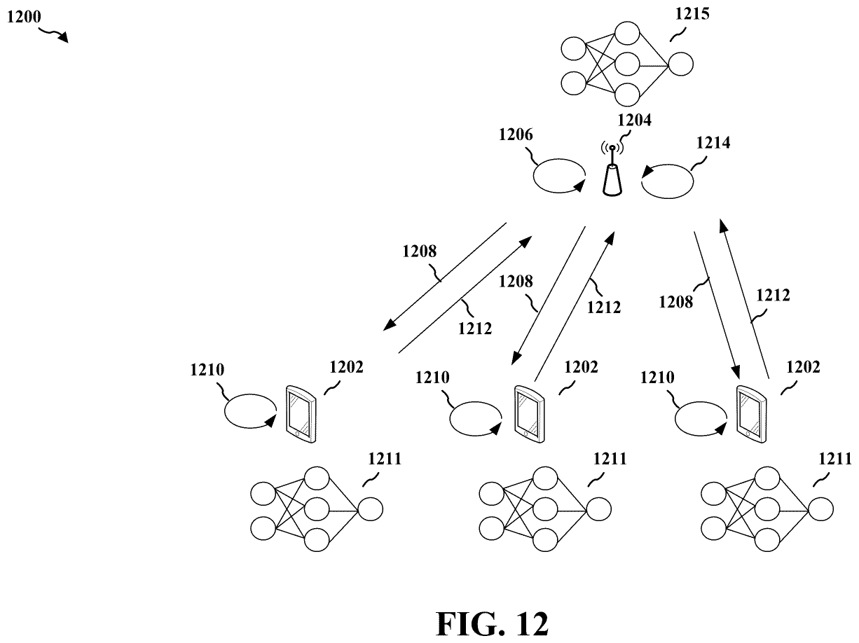

FIG. 12 illustrates an example 1200 of a signaling procedure in which participant nodes 1202 may perform intra-cluster FL following selection or nomination of a leader node 1204 (e.g., a cluster leader) and clustering of the participant nodes 1202 such as described with respect to FIG. 10 or 11. The participant nodes 1202 (e.g., UEs) may be, for example, cluster members in a cluster Ci. The leader node 1204 (e.g., a RSU, edge server, a local FL server, or other network node) may be for example, a selected or self-nominated leader of the cluster Ci.

Initially, at step 1206, the leader node 1204 may initialize a ML model (e.g., a cluster model W₀^{Ci} for clustered FL). The initialization may include, for example, configuring a ML task (e.g., object detection), a neural network (e.g., a CNN), a quantity of neurons and synapses, random weights and biases, a model algorithm (e.g., logistic regression), and other model parameters. Following initialization, at step 1208, the leader node 1204 may broadcast or groupcast these ML model parameters to the network nodes 1202 for download.

Upon receiving the ML model parameters from the leader node 1204 and configuring their local ML models accordingly, at step 1210, the participant nodes 1202 (e.g., k cluster members) and potentially the leader node 1204 may perform local ML model training based on their respective datasets. For instance, during a given FL iteration t, a respective node k (corresponding to cluster model Wₜ^{Cik}) may train a local ML model 1211 to identify the optimal model parameters for minimizing a loss function F (Wₜ^{Cik}), such as described with respect to FIG. 6. For example, the node may utilize backpropagation and stochastic gradient descent to identify the optimum model weights to be applied to its respective neural network which result in a minimized cross-entropy loss following multiple training sessions. Afterwards, the participant nodes 1202 may upload their respectively updated ML model parameters (updated ML model 1212) to the leader node 1204. For example, the participant nodes 1202 may transmit the optimized ML model weights and other information to the leader node 1204. Following receipt of these ML model information updates from the participant nodes 1202, at step 1214, the leader node 1204 may aggregate the updates to generate an updated ML model 1215 for the nodes (e.g., an updated cluster model Wₜ₊₁^{Ci} to be applied for the next FL iteration t+1). For example, the leader node 1204 may average or perform some other calculation on the respective model weights indicated by the participant nodes 1202, including potentially the respective model weights of the leader node 1204.

After generating the aggregated ML model information, the leader node 1204 may determine that a loss function associated with the updated ML model is no longer minimized. For example, the aggregated ML model weights may potentially result in increased loss compared to the previous ML model weights for individual nodes. As a result, the leader node may send the aggregated ML model information to the participant nodes 1202, which may be the same nodes as before or may include additional or less nodes, to utilize for further local ML model training. For instance, after configuring their local ML models with the updated weights, during this next FL iteration t+1, the participant nodes 1202 (and potentially the leader node 1204) may again perform local ML model training to arrive at an optimum set of ML model weights for their individual models, and the participant nodes 1202 may similarly send their updated ML models to the leader node 1204 for further aggregation. This process may repeat until a minimization of a loss function associated with the aggregated ML model (e.g., the cluster loss function F (Wₜ^{Ci}) for cluster Ci) is achieved. Alternatively, this process may repeat until a predetermined quantity of FL iterations in the cluster has occurred (e.g., a quantity based on the computational capabilities or other ML model information of the participant nodes 1202).

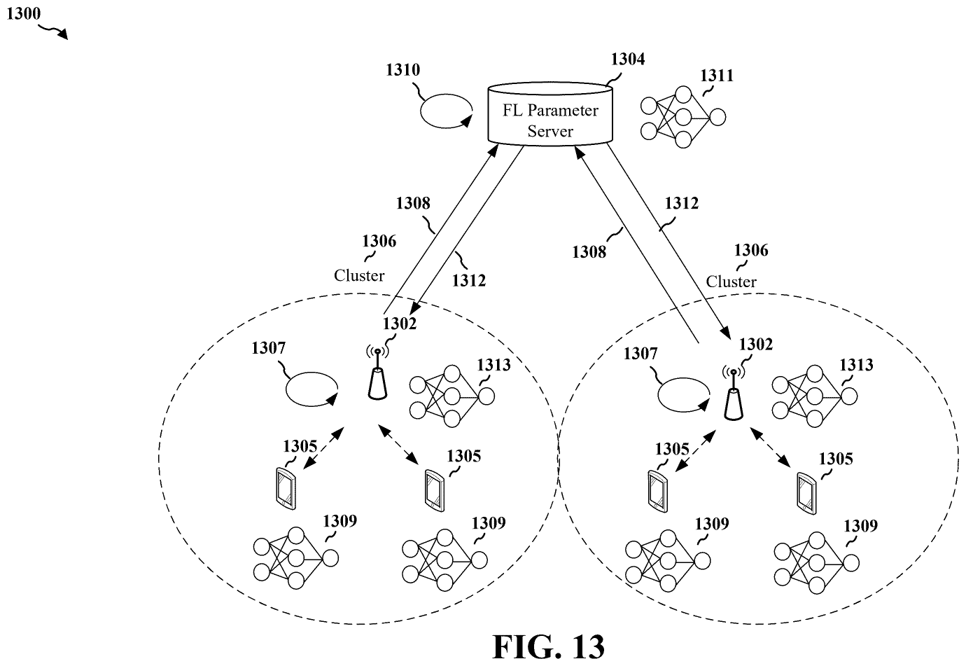

FIG. 13 illustrates an example 1300 of a signaling procedure in which leader nodes 1302 may communicate with an FL parameter server 1304 to perform inter-cluster FL following one or more FL iterations of intra-cluster model training with participant nodes 1305 as described with respect to FIG. 12. The leader nodes 1302 (e.g., RSUs or edge servers) may be for example, selected or self-nominated leaders of respective clusters 1306. The FL parameter server 1304 may be, for example, a base station or other network entity which coordinates FL between the respective clusters 1306. At given instances of time following intra-cluster FL training, the leader nodes 1302 may communicate locally updated ML model information (intra-cluster) to the FL parameter server 1304 for inter-cluster FL training. For example, the FL parameter server 1304 may periodically or aperiodically send requests to cluster leaders to communicate their model updates for inter-cluster FL training. Alternatively, the leader nodes 1302 themselves may communicate their model updates for inter-cluster FL training in response to an event trigger, such as a minimization of a local loss function in a respective cluster or an occurrence of a certain quantity of intra-cluster FL iterations. The FL parameter server 1304 may aggregate this information received from the respective cluster leaders to generate global (multi-cluster) ML model updates, after which the FL parameter server may provide this globally updated ML model information to the respective leader nodes. These leader nodes may in turn provide the globally updated ML model information to their respective participant nodes for further refinement of local ML models through additional intra-cluster FL training. The intra-cluster and inter-cluster FL training may or may not be synchronized; for example, different clusters may perform intra-cluster FL training or inter-cluster FL training over a same quantity or different quantities of iterations before ceasing to perform FL training. For instance, the leader nodes 1302 of respective clusters may stop communicating local model updates (in intra-cluster training) or global model updates (in inter-cluster training) to participating nodes or the FL parameter server simultaneously or at different times.

Initially, at step 1308, the leader node 1302 of a respective cluster may send its updated ML model Wₜ^{Ci} for its cluster Ci, which includes one or more previous aggregations 1307 of local ML model updates 1309 from follower nodes, to the FL parameter server 1304. For instance, the leader node 1302 may send the aggregated ML model weights that it most recently generated after a given quantity of intra-cluster FL iterations, for further aggregation with other aggregated ML model weights generated by other leader nodes in other clusters. The leader node 1302 may be triggered to send the updated ML model for this inter-cluster FL training, for example, in response to receiving a request from the FL parameter server 1304, achieving a minimization of a loss function associated with the updated ML model (e.g., the cluster loss function F (Wₜ^{Ci}) for cluster), or an occurrence of a predetermined quantity of FL iterations in the cluster. Similarly, the leader nodes 1302 of other respective clusters may send their updated ML models (e.g., aggregated ML model weights) respectively for their own clusters to the FL parameter server 1304 for inter-cluster FL training in response to similar events.

After receiving the updated ML models from the cluster leaders, at step 1310, the FL parameter server 1304 may aggregate the updates to generate an updated global ML model 1311 for the leader nodes (e.g., an updated global model Wₜ₊₁^{G}). For example, the FL parameter server 1304 may average or perform some other calculation on the respective, aggregated model weights indicated by the leader nodes 1302. After generating the aggregated ML model information, the FL parameter server 1304 may determine that a global loss function associated with the updated ML model is no longer minimized. For example, the aggregated ML model weights across clusters may potentially result in increased loss compared to the previous updated ML model weights for individual cluster leaders. As a result, at step 1312, the FL parameter server may send the aggregated ML model information to the leader nodes 1302 to utilize for further training of respective intra-cluster ML models 1313 (beginning from the updated model Wₜ₊₁^{G}) such as described with respect to FIG. 12. Following this intra-cluster FL training, the leader nodes 1302 may again send their updated or aggregated ML model information to the FL parameter server 1304 for further inter-cluster FL training, and this process may repeat until a minimization of the global loss function associated with the aggregated ML model across clusters (e.g., the global loss function F_{G} (Wₜ^{G})) is achieved. Alternatively, this process may repeat until a predetermined quantity of inter-cluster FL iterations has occurred.

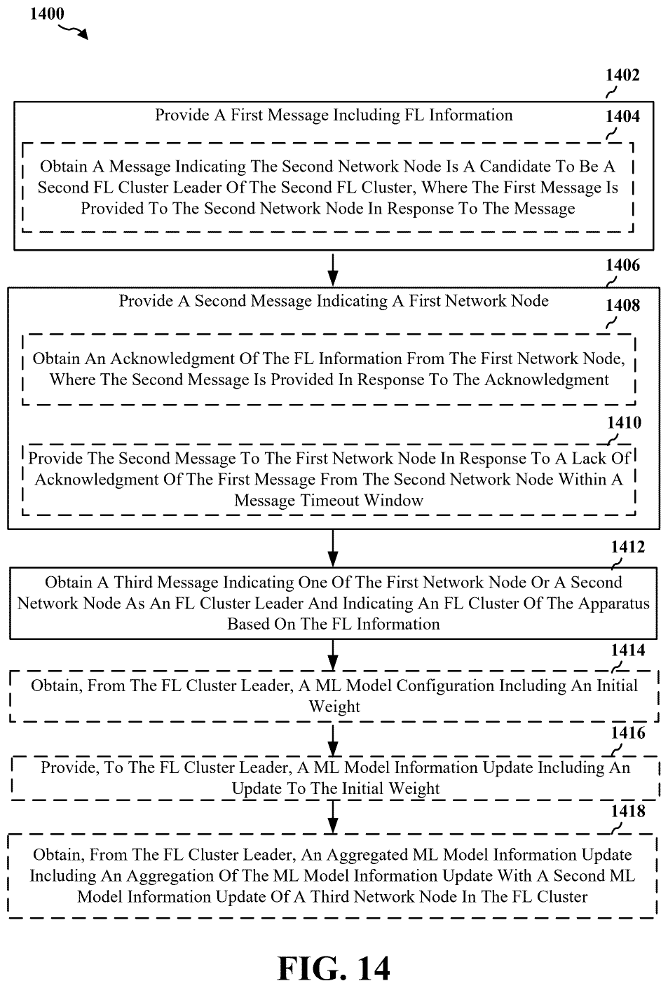

FIG. 14 is a flowchart 1400 of a method of wireless communication. The method may be performed by a UE (e.g., the UE 104, 904, 1002; device 410, 450; learning node 706; network node 802, 852, 1104, 1202, 1305; the apparatus 1602). For example, the method may be performed by the controller/processor 459, 475 coupled to memory 460, 476 of device 410, 450. Optional aspects are illustrated in dashed lines. The method allows a UE to be grouped with other UEs in a cluster led by another network node (e.g., an RSU or edge server) so that the UE may perform ML model training in a clustered FL environment through various signaling procedures.

At 1402, the UE may provide a first message including FL information. For example, 1402 may be performed by cluster formation component 1640. For instance, referring to FIG. 4, the controller/processor 475 in device 410 (e.g., the UE) may provide the first message to device 450 (e.g., another node such as an RSU or edge server) via TX processor 416, which may transmit the first message via antennas 420 to device 450. In one example, referring to FIG. 10, the UE 1002 may provide FL message 1008 to RSUs 1006 as prospective cluster leaders. The FL message 1008 may indicate FL or model training-related information of the UE 1002. In another example, referring to FIG. 11, the second node 1104 (the UE in this example) may provide message 1108 to first node 1102 (e.g., an RSU or edge server) requesting to subscribe to or join with its cluster. The message 1108 may indicate model training-related information of the second node 1104.

In one example, the FL information may comprise at least one of: a machine learning task of the UE, an available sensor coupled to the UE for the machine learning task, an available ML model associated with the machine learning task, or an available computation resource of the UE for the machine learning task. For instance, referring to FIGS. 10 and 11, the FL or model training-related information of the UE 1002 or second node 1104 provided in FL message 1008 or message 1108 may include, for example, ML tasks that the UE is participating in or is interested in participating in, available sensors at the UE and their associated data input format, available ML models in training including model status, model architectures, model training parameters, and current performance (e.g., accuracy and loss), and available computation resources (e.g., whether the UE includes a CPU or GPU, information about its clock speed, available memory, etc.). As an example, the FL message 1008 or message 1108 may indicate that the UE is configured to perform object detection (e.g., to identify OBBs), image classification, reinforcement learning, or other ML task. The FL message 1008 or message 1108 may indicate that the UE includes a camera, LIDAR, RADAR, IMU, or other sensor, and data format(s) that are readable by the indicated sensor(s). The FL message 1008 or message 1108 may indicate that the UE is configured with a neural network (e.g., the CNN of FIG. 6, a DNN, a DCN, a RNN, or other ANN), a quantity of neurons and synapses, a logistic regression or classification model, current values for model weights and biases, an applied activation function (e.g., ReLU), a classification accuracy, and a loss function applied for model weight updates (e.g., a cross-entropy loss function). The FL message 1008 or message 1108 may indicate that a CPU or GPU of the UE (e.g., controller/processor 459 or some other processor of device 450) applies the indicated neural network(s) and model(s) for the indicated ML task(s), a clock speed of the CPU or GPU, and a quantity of available memory (e.g., memory 460 or some other memory of device 450) for storing information associated with the ML task, neural network, data, etc. The FL message 1008 or message 1108 may include any combination of the foregoing, as well as other information.

In one example, the UE may provide the first message periodically or in response to an event trigger. For instance, referring to FIG. 10, the FL message 1008 may be provided periodically (e.g., with a pre-configured periodicity), or in response to an event. In one example of an event, the UE may be triggered to send the FL message 1008 upon entering a service coverage area of an RSU or base station. In another example of an event, the UE may be triggered to send the FL message 1008 in response to a decision by the UE to join an FL cluster to improve the accuracy of its ML model. For instance, the UE may provide FL message 1008 if its classification accuracy or other evaluation metric falls below a threshold.

In one example, the UE may provide the first message in a broadcast. For instance, referring to FIG. 10, the FL message 1008 may be broadcast in order to solicit a response from any RSU capable of decoding the FL message. For instance, in the illustrated example of FIG. 10, RSU 1 may be proximal to (e.g., a neighbor of) both UE 1 and UE 2 and thus successfully decode the FL messages of both UE 1 and UE 2, while RSU 2 may be proximal to UE 2 and thus successfully decode the FL message of UE 2. Thus, one UE may provide an FL message to multiple RSUs, and one RSU may obtain an FL message respectively from multiple UEs.

In one example, the UE may provide the first message (at 1402) to a second network node. In this example, the first message may further include a request to join a second FL cluster of the second network node. For instance, referring to FIG. 11, the UE (second node 1104) may provide message 1108 to a second network node (first node 1102) requesting to subscribe to or join with its cluster.

At 1404, the UE may obtain a message indicating the second network node is a candidate to be a second FL cluster leader of the second FL cluster, where the first message is provided (at 1402) to the second network node in response to the message.

For example, 1404 may be performed by cluster formation component 1640. For instance, referring to FIG. 4, the controller/processor 475 in device 410 (the UE) may obtain the message from device 450 (e.g., another network node such as a RSU or edge server) via RX processor 470, which may receive the message from device 450 via antennas 420. For example, referring to FIG. 11, the UE (second node 1104) may receive message 1106 from a second network node (first node 1102) indicating that the first node 1102 is interested in recruiting other nodes to form or join a cluster led by the first node. This recruitment message may indicate that the network node intends to operate as (e.g., is a candidate to be) a cluster leader and FL coordinator as well as indicate ML training-related information of the network node. In response to receiving message 1106, the UE (second node 1104) may provide message 1108 (the first message) to the second network node (first node 1102) requesting to subscribe to or join with its cluster.

At 1406, the UE may provide a second message indicating a first network node. For example, 1406 may be performed by cluster formation component 1640. For instance, referring to FIG. 4, the controller/processor 475 in device 410 (e.g., the UE) may provide the second message to device 450 (e.g., another node such as an RSU or edge server) via TX processor 416, which may transmit the second message via antennas 420 to device 450. In one example, referring to FIG. 10, UE 1002 may provide RSU indication message 1012 to RSUs 1006 which includes the identifier of a selected RSU (the first network node) to act as a delegate of the UE for passing its FL information to the base station 1004 for cluster formation and leader selection. In another example, referring to FIG. 11, the UE (second node 1104) may transmit message 1118 to third node 1116 (the first network node) requesting to subscribe to or join the cluster led by the third node 1116.

At 1408, the UE may obtain an acknowledgment of the FL information from the first network node, where the second message is provided (at 1406) in response to the acknowledgment. For example, 1408 may be performed by cluster formation component 1640. For instance, referring to FIG. 10, the UE 1002 may obtain FL message acknowledgment 1010 confirming receipt of FL message 1008 (including the FL information) from a respective RSU. As an example, referring to FIG. 4, the controller/processor 475 in device 410 (the UE) may obtain the acknowledgment from device 450 (e.g., another network node such as a RSU or edge server) via RX processor 470, which may receive the acknowledgment from device 450 via antennas 420. In response to obtaining the FL message acknowledgment 1010, the UE may provide the RSU indication message 1012 (the second message) including the identifier of a selected RSU from the acknowledging RSUs.

At 1410, the UE may provide the second message (at 1406) to the first network node in response to a lack of acknowledgment of the first message (provided at 1402) from the second network node within a message timeout window. For example, 1410 may be performed by cluster formation component 1640. For instance, referring to FIG. 11, the UE (second node 1104) may provide message 1118 (the second message in this example) to third node 1116 (the first network node in this example) if the UE fails to receive message 1110 acknowledging its admission to a cluster of another node (first node 1102) within timeout window 1112. In one example, the second message may further include the FL information. For instance, the message 1118 may request to subscribe to or join the cluster led by third node 1116, and may also indicate model training-related information of the UE (second node 1104). This information may include, for example, ML tasks that the second node 1104 is participating in or is interested in participating in, available sensors at the second node and their associated data input format, available ML models in training including model status, model architectures, model training parameters, and current performance (e.g., accuracy and loss), and available computation resources (e.g., whether the second node includes a CPU or GPU, information about its clock speed, available memory, etc.).

At 1412, the UE may obtain a third message indicating one of the first network node or the second network node as an FL cluster leader and indicating an FL cluster of the UE based on the FL information. For example, 1412 may be performed by cluster formation component 1640. The first network node and the second network node may be, for example, RSUs or edge servers. For instance, referring to FIG. 4, the controller/processor 475 in device 410 (the UE) may obtain the third message from device 450 (e.g., another network node such as a RSU or edge server) via RX processor 470, which may receive the third message from device 450 via antennas 420. In one example, referring to FIG. 10, the UE 1002 may receive from the RSU 1006 which the UE identified in its RSU indication message 1012 (the first network node) or from a different RSU (the second network node), message 1018 (the third message) informing the UE of its status as a participant or follower node for FL in a cluster (e.g., cluster 902 of FIG. 9) led by the respective RSU (the first network node or second network node), and instructing that UE to provide its ML model weight updates to that RSU for training and optimization during clustered FL. The RSU selected to serve as cluster leader, and the UEs selected to be members or participants of a cluster led by that RSU, may be based on aggregated FL information from the UE 1002 and the other UEs. In another example, referring to FIG. 11, the UE (second node 1104) may receive message 1110 (one example of the third message) acknowledging admission of the UE to a cluster led by first node 1102, or a message 1120 (another example of the third message) acknowledging admission of the UE to a cluster led by third node 1116 (e.g., the first network node or the second network node), in response to sending message 1108 or message 1118 including its FL or model training-related information to the respective node.

In one example, the UE may obtain the third message indicating the FL cluster leader and the FL cluster of the UE in a groupcast from the first network node. For instance, referring to FIG. 10, UE 1002 may receive message 1018 via groupcast from the RSU 1006 (the first network node) indicating that UE is a cluster member of a cluster led by that RSU.

In one example, the third message may indicate the first network node as the FL cluster leader following step 1410. For instance, referring to FIG. 11, after the UE (second node 1104) provides message 1118 to third node 1116 (the first network node in this example), the UE may obtain message 1120 (the third message) acknowledging admission of the UE (second node 1104 to the cluster led by third node 1116.

At 1414, the UE may obtain, from the FL cluster leader, a ML model configuration including an initial weight. For example, 1414 may be performed by FL training component 1642. For instance, referring to FIG. 4, the controller/processor 475 in device 410 (the UE) may obtain the ML model configuration from device 450 (e.g., another network node such as a RSU or edge server) via RX processor 470, which may receive the ML model configuration from device 450 via antennas 420. As an example, referring to FIG. 12, participant node 1202 (the UE) may receive ML model parameters at step 1208, which parameters were initialized by leader node 1204 at step 1206. The leader node's initialization may include, for example, configuring a ML task (e.g., object detection), a neural network (e.g., a CNN), a quantity of neurons and synapses, random weights and biases, a model algorithm (e.g., logistic regression), and other model parameters. Thus, the initial weight (e.g., an initial value of weight 616 in FIG. 6) may a random weight.

At 1416, the UE may provide, to the FL cluster leader, a ML model information update including an update to the initial weight. For example, 1416 may be performed by FL training component 1642. For instance, referring to FIG. 4, the controller/processor 475 in device 410 (e.g., the UE) may provide the ML model information update to device 450 (e.g., another node such as an RSU or edge server) via TX processor 416, which may transmit the ML model information update via antennas 420 to device 450. As an example, referring to FIG. 12, upon receiving the ML model parameters from the leader node 1204 and configuring their local ML models accordingly, at step 1210, the participant node 1202 (the UE) may perform local ML model training based on its respective dataset. For instance, during a given FL iteration t, a respective node k (corresponding to cluster model Wₜ^{Cik}) may train local ML model 1211 to identify the optimal model parameters for minimizing a loss function F (Wₜ^{Cik}), such as described with respect to FIG. 6. For example, the node may utilize backpropagation and stochastic gradient descent to identify the optimum model weights to be applied to its respective neural network which result in a minimized cross-entropy loss following multiple training sessions. Afterwards, the participant node 1202 may upload its respectively updated ML model parameters (updated ML model 1212) to the leader node 1204. For example, the participant node 1202 may transmit the optimized ML model weights and other information to the leader node 1204.

At 1418, the UE may obtain, from the FL cluster leader, an aggregated ML model information update including an aggregation of the ML model information update with a second ML model information update of a third network node in the FL cluster. For example, 1418 may be performed by FL training component 1642. For instance, referring to FIG. 4, the controller/processor 475 in device 410 (the UE) may obtain the aggregated ML model information update from device 450 (e.g., another network node such as a RSU or edge server) via RX processor 470, which may receive the aggregated ML model information update from device 450 via antennas 420. As an example, referring to FIG. 12, following receipt of the ML model information updates from participant nodes 1202, including the update from the UE and another update of a different UE, e.g., the third network node, in the same cluster, at step 1214, the leader node 1204 may aggregate the updates to generate updated ML model 1212 for the nodes (e.g., an updated cluster model Wₜ₊₁^{Ci} to be applied for the next FL iteration t+1). For example, the leader node 1204 may average or perform some other calculation on the respective model weights indicated by the participant nodes 1202. After the leader node 1204 generates the aggregated ML model information, the participant nodes 1202 may receive the aggregated ML model information from the leader node 1204.

In one example, the aggregated ML model information update may further include a second aggregation of the ML model information update with a third ML model information update of a fourth network node in a second FL cluster. For instance, referring to FIG. 13, at step 1308, the leader node 1302 of a respective cluster may send the updated ML model Wₜ^{Ci} for its cluster Ci (the ML model information update in this example), which includes one or more previous aggregations 1307 of local ML model updates 1309 from follower nodes (e.g., participant nodes 1202 of FIG. 12), to the FL parameter server 1304. For instance, the leader node 1302 may send the aggregated ML model weights that it most recently generated after a given quantity of intra-cluster FL iterations, for the FL parameter server to further aggregate (in a second aggregation) with other aggregated ML model weights (the third ML model information update in this example) generated by other leader nodes (including the fourth network node in this examples) in other clusters (including the second FL cluster). After receiving the updated ML models from the cluster leaders, at step 1310, the FL parameter server 1304 may aggregate the updates to generate the updated global ML model 1311 for the leader nodes (e.g., an updated global model Wₜ₊₁^{G}). For example, the FL parameter server 1304 may average or perform some other calculation on the respective, aggregated model weights indicated by the leader nodes 1302. As a result, at step 1312, the FL parameter server may send the aggregated ML model information to the leader nodes 1302 to utilize for further training of respective intra-cluster ML models 1313 (beginning from the updated model Wₜ₊₁^{G}) such as described with respect to FIG. 12. The UE (e.g., participant node 1202 of FIG. 12) may subsequently obtain this further aggregated update (e.g., updated ML model 1212) from the leader node.

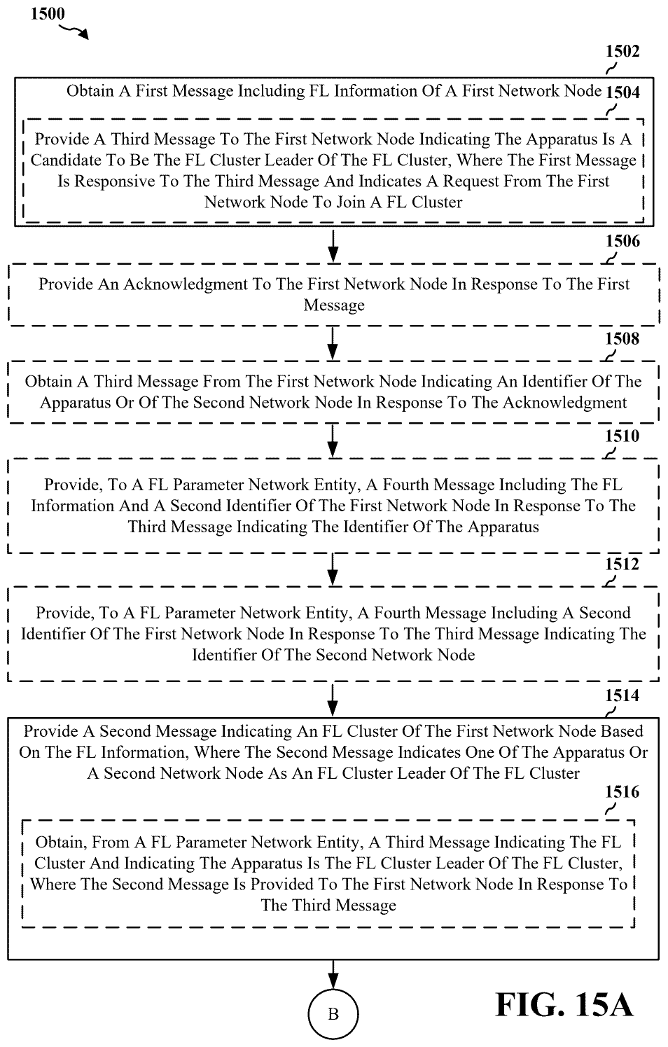

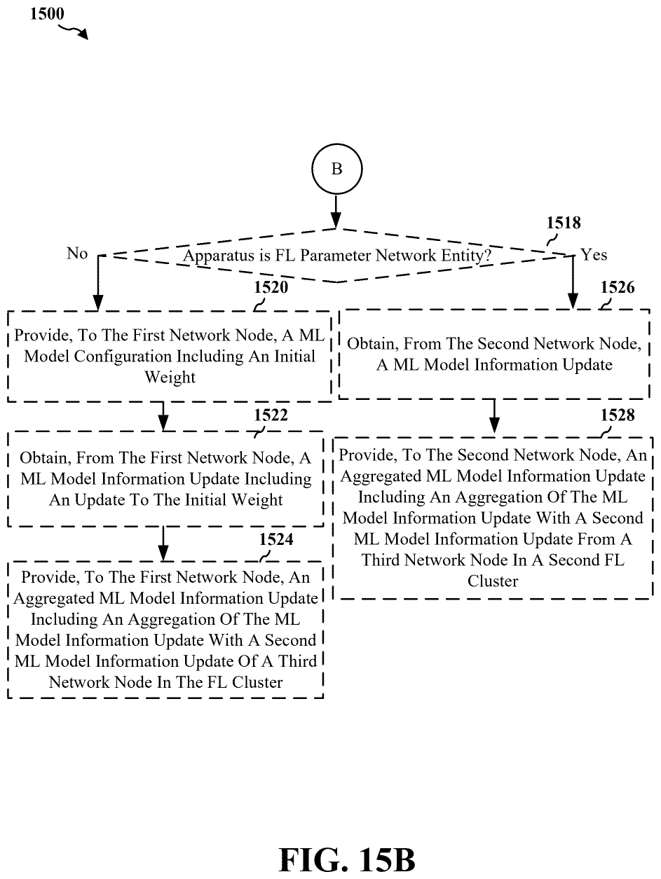

FIGS. 15A-15B are a flowchart 1500 of a method of wireless communication. The method may be performed by a network node, such as an RSU, edge server, base station, FL parameter server, or other network node (e.g., the base station 102/180; disaggregated base station 181; device 410, 450; FL parameter server 702, 804, 854, 906, 1304; cluster leader 908; base station 1004; RSU 1006; node 1102, 1116; leader node 1204, 1302; the apparatus 1702). For example, the method may be performed by the controller/processor 459, 475 coupled to memory 460, 476 of device 410, 450. Optional aspects are illustrated in dashed lines. The method allows a network node such as a base station, RSU, or edge server to designate cluster leaders and form clusters of UEs led by those cluster leaders so that the UEs may perform ML model training in a clustered FL environment through various signaling procedures.

Referring to FIG. 15A, at 1502, the network node may obtain a first message including FL information of a first network node. For example, 1502 may be performed by cluster formation component 1740. For instance, referring to FIG. 4, the controller/processor 475 in device 410 (the network node such as an RSU) may obtain the first message from device 450 (e.g., another network node such as a UE) via RX processor 470, which may receive the first message from device 450 via antennas 420. In one example, referring to FIG. 10, the RSU 1006 (the network node) may receive FL message 1008 (the first message) including FL or model training-related information (the FL information) of UE 1002 (the first network node). In another example, referring to FIG. 11, the first node 1102 (the network node) may receive message 1108 (the first message) including model training-related information (the FL information) of second node 1104 (the first network node). In a further example, referring to FIG. 10, the base station 1004 (the network node) may obtain message 1014 (the first message) including FL or model training-related information (the FL information) of UE 1002 (the first network node).

At 1504, the network node may provide a third message to the first network node indicating the apparatus is a candidate to be a FL cluster leader of an FL cluster, where the first message is responsive to the third message and indicates a request from the first network node to join a FL cluster. For example, 1504 may be performed by cluster formation component 1740. For instance, referring to FIG. 4, the controller/processor 475 in device 410 (e.g., the network node such as an RSU) may provide the first message to device 450 (e.g., another node such as a UE) via TX processor 416, which may transmit the third message via antennas 420 to device 450. As an example, referring to FIG. 11, the first node 1102 (the network node) may provide message 1106 (the third message) to the second node 1104 (the first network node) indicating the first node 1102 is a candidate to be an FL cluster leader of an FL cluster (e.g., cluster 902 in FIG. 9). In response to the providing message 1106 (the third message), the first node 1102 (the network node) may obtain message 1108 (the first message) from the second node 1104 (the first network node) requesting to subscribe to the first node's cluster.

In one example, the network node may provide the third message periodically or in response to an event trigger. For instance, referring to FIG. 11, the first node 1102 (the network node) may provide message 1106 (the third message) periodically (e.g., according to a pre-configured periodicity), for example, if the first node is not currently participating in an active clustered FL session. Alternatively, the message 1106 may be event-triggered, for example, in response to the first node 1102 determining to train or update a ML model of a UE to improve performance of a certain ML task by that UE.

In one example, the network node may provide the third message in a broadcast or in a groupcast to a plurality of network nodes including the first network node. For instance, referring to FIG. 11, the first node 1102 (the network node) may broadcast the message 1106 to any network node including the second node 1104 (the first network node) which is capable of decoding the message. Alternatively, the message 1106 may be groupcast, for example, to network nodes of which the first node 1102 is aware (including the second node 1104). The message 1106 may also be sent using groupcast option 1 to enhance reliability of the recruitment message (e.g., the first node 1102 may indicate in second stage SCI a distance within which the first node expects to receive NACKs from other nodes who fail to decode the message).

In one example, the third message may include second FL information of the apparatus. For instance, referring to FIG. 11, the message 1106 (the third message) may indicate model training-related information (the second FL information) of the first node 1102 (the network node or apparatus). This information may include, for example, ML tasks that the first node 1102 is participating in or is interested in participating in, available ML models in training including model status, model architectures, model training parameters, and current performance (e.g., accuracy and loss), and available computation resources (e.g., whether the first node 1102 includes a CPU or GPU, information about its clock speed, available memory, etc.). Thus, the message 1106 may include similar types of information as those provided in the message 1014 of FIG. 10.

At 1506, the network node may provide an acknowledgment to the first network node in response to the first message. For example, 1506 may be performed by cluster formation component 1740. For instance, referring to FIG. 4, the controller/processor 475 in device 410 (e.g., the network node such as an RSU) may provide the acknowledgment to device 450 (e.g., another node such as a UE) via TX processor 416, which may transmit the acknowledgment via antennas 420 to device 450. As an example, referring to FIG. 10, the RSU 1006 may provide, to UE 1002 (the first network node), the FL message acknowledgment 1010 acknowledging receipt of the FL message 1008 (the first message).

At 1508, the network node may obtain a third message from the first network node indicating an identifier of the apparatus or of a second network node in response to the acknowledgment. For example, 1508 may be performed by cluster formation component 1740. For instance, referring to FIG. 4, the controller/processor 475 in device 410 (the network node such as an RSU) may obtain the third message from device 450 (e.g., another network node such as a UE) via RX processor 470, which may receive the third message from device 450 via antennas 420. As an example, referring to FIG. 10, in response to providing the FL message acknowledgment 1010 (the acknowledgment), the RSU 1006 (the network node) may obtain RSU indication message 1012 (the third message) from the UE 1002 (the first network node) indicating an identifier of the RSU 1006 (the apparatus, such as RSU 1) or a different RSU (the second network node, such as RSU 2) selected depending on which RSU the UE delegated for FL message passing to base station 1004.

At 1510, the network node may provide, to a FL parameter network entity, a fourth message including the FL information and a second identifier of the first network node in response to the third message indicating the identifier of the apparatus. For example, 1510 may be performed by cluster formation component 1740. The fourth message may further include second FL information of the apparatus. For instance, referring to FIG. 4, the controller/processor 475 in device 410 (e.g., the network node such as an RSU) may provide the fourth message to device 450 (e.g., a base station, FL parameter server, or other FL parameter network entity) via TX processor 416, which may transmit the fourth message via antennas 420 to device 450. As an example, referring to FIG. 10, in response to receiving RSU indication message 1012 (the third message) from UE 1002 which indicates the identifier of the RSU 1006 (the apparatus or network node, such as RSU 1), the RSU 1006 (e.g., RSU 1) may provide to base station 1004 (the FL parameter network entity in this example) the message 1014 (the fourth message) including the FL information of the UE 1002 which indicated the RSU's identifier and a list (or other data structure) of the identifiers (including the second identifier) of the UEs 1002 (including the first network node) which the RSU has previously acknowledged.

At 1512, the network node may provide, to a FL parameter network entity, a fourth message including a second identifier of the first network node in response to the third message indicating the identifier of the second network node. For example, 1512 may be performed by cluster formation component 1740. For instance, referring to FIG. 4, the controller/processor 475 in device 410 (e.g., the network node such as an RSU) may provide the fourth message to device 450 (e.g., a base station, FL parameter server, or other FL parameter network entity) via TX processor 416, which may transmit the fourth message via antennas 420 to device 450. As an example, referring to FIG. 10, in response to receiving RSU indication message 1012 (the third message) from UE 1002 which indicates the identifier of a different RSU (the second network node, such as RSU 2), the RSU 1006 (the network node, such as RSU 1) may provide to base station 1004 (the FL parameter network entity in this example) the message 1014 (the fourth message) including a list (or other data structure) of the identifiers (including the second identifier) of the UEs 1002 (including the first network node) which the RSU has previously acknowledged.

At 1514, the network node may provide the second message indicating an FL cluster of the first network node based on the FL information, where the second message indicates one of the apparatus or a second network node as an FL cluster leader of the FL cluster. For example, 1514 may be performed by cluster formation component 1740. For instance, referring to FIG. 4, the controller/processor 475 in device 410 (e.g., the network node such as an RSU, edge server, base station, FL parameter server, or other node) may provide the second message to device 450 (e.g., another network node such as an RSU, edge server, base station, FL parameter server, or other node) via TX processor 416, which may transmit the second message via antennas 420 to device 450. In one example, referring to FIG. 10, the RSU 1006 (the network node) may provide message 1018 (the second message) indicating an FL cluster (e.g., cluster 902, 1306) of UE 1002 (the first network node) in response to receiving the FL information from UE 1002 in FL message 1008, where message 1018 indicates the RSU 1006 (the apparatus or network node) is an FL cluster leader (e.g., leader node 1204, 1302) of the cluster including UE 1002. In another example, referring to FIG. 11, the first node 1102 (the network node) may provide message 1110 (the second message) indicating an FL cluster of the second node 1104 (the first network node) in response to receiving the FL information from the second node 1104 in message 1108, where message 1110 indicates the first node 1102 (the apparatus or network node) is an FL cluster leader of the cluster including the second node 1104. In a further example, referring to FIG. 10, the base station 1004 (the network node) may provide message 1016 (the second message) indicating an FL cluster of UE 1002 (the first network node) in response to receiving the FL information from RSU 1006 in message 1014, where message 1014 indicates the RSU 1006 (the second network node) is an FL cluster leader of the cluster including UE 1002.

At 1516, the network node may obtain, from a FL parameter network entity, a third message indicating the FL cluster and indicating the apparatus is the FL cluster leader of the FL cluster, where the second message is provided to the first network node in response to the third message. For example, 1516 may be performed by cluster formation component 1740. For instance, referring to FIG. 4, the controller/processor 475 in device 410 (the network node such as an RSU) may obtain the third message from device 450 (e.g., a base station, FL parameter server, or other FL parameter network entity) via RX processor 470, which may receive the third message from device 450 via antennas 420. As an example, referring to FIG. 10, the RSU 1006 (the apparatus or network node) may obtain, from base station 1004 (the FL parameter network entity), message 1016 (the third message) indicating the FL cluster (e.g., cluster 902, 1306) of UE 1002 and that the RSU 1006 is the FL cluster leader (e.g., leader node 1204, 1302) of this cluster. In response to obtaining the message 1016 (the third message), the RSU 1006 may provide message 1018 (the second message) to the UE 1002 (the first network node).

In one example, the second message may be groupcast to a plurality of network nodes including the first network node in the FL cluster. For instance, referring to FIG. 10, the RSU 1006 may provide message 1018 via groupcast to those UEs 1002 (the network nodes including the first network node in the cluster, such as UE 1) having identifiers assigned or indicated in the cluster information of message 1016.

In one example, the second message may acknowledge an admission of the first network node to the FL cluster. For instance, referring to FIG. 11, the first node 1102 may provide (e.g., via unicast) message 1110 (the second message) acknowledging admission of the second node 1104 (the first network node) to the FL cluster (e.g., cluster 902, 1306) led by the first node 1102 (e.g., leader node 1204, 1302).

Referring to FIG. 15B, at 1518, depending on whether or not the network node is an FL parameter network entity (e.g., a base station or an FL server that may otherwise perform inter-cluster FL), the process may branch in different directions. If the network node is not an FL parameter network entity (e.g., if the network node is a cluster leader such as an RSU, edge server, or an FL server that may otherwise perform intra-cluster FL), then the process continues at 1520, 1522, and 1524. Otherwise, if the network node is an FL parameter network entity, then the process continues at 1526 and 1528.

At 1520, the network node may provide, to the first network node, a ML model configuration including an initial weight. For example, 1520 may be performed by FL training component 1742. For instance, referring to FIG. 4, the controller/processor 475 in device 410 (e.g., the network node such as an RSU) may provide the ML model configuration to device 450 (e.g., a UE) via TX processor 416, which may transmit the ML model configuration via antennas 420 to device 450. As an example, referring to FIG. 12, leader node 1204 (the network node) may provide to participant node 1202 (the first network node) ML model parameters (the ML model configuration) at step 1208, which parameters were initialized by leader node 1204 at step 1206. The leader node's initialization may include, for example, configuring a ML task (e.g., object detection), a neural network (e.g., a CNN), a quantity of neurons and synapses, random weights and biases, a model algorithm (e.g., logistic regression), and other model parameters. Thus, the initial weight (e.g., an initial value of weight 616 in FIG. 6) may a random weight.

At 1522, the network node may obtain, from the first network node, a ML model information update including an update to the initial weight. For example, 1522 may be performed by FL training component 1742. For instance, referring to FIG. 4, the controller/processor 475 in device 410 (the network node such as an RSU) may obtain the ML model information update from device 450 (e.g., the UE) via RX processor 470, which may receive the ML model information update from device 450 via antennas 420. As an example, referring to FIG. 12, upon receiving the ML model parameters from the leader node 1204 and configuring their local ML models accordingly, at step 1210, the participant node 1202 (the first network node) may perform local ML model training based on its respective dataset. For instance, during a given FL iteration t, a respective node k (corresponding to cluster model Wₜ^{Cik}) may train local ML model 1211 to identify the optimal model parameters for minimizing a loss function F (Wₜ^{Cik}), such as described with respect to FIG. 6. For example, the node may utilize backpropagation and stochastic gradient descent to identify the optimum model weights to be applied to its respective neural network which result in a minimized cross-entropy loss following multiple training sessions. Afterwards, the participant node 1202 may upload its respectively updated ML model parameters (updated ML model 1212) to the leader node 1204. For example, the participant node 1202 may transmit the optimized ML model weights and other information to the leader node 1204. Thus, the leader node 1204 (the network node) may obtain, from the participant node 1202 (the first network node), the updated ML model parameters (the ML model information update) including an optimum model weight for its neural network (the update to the initial weight).

At 1524, the network node may provide, to the first network node, an aggregated ML model information update including an aggregation of the ML model information update with a second ML model information update of a third network node in the FL cluster. For example, 1524 may be performed by FL training component 1742. For instance, referring to FIG. 4, the controller/processor 475 in device 410 (e.g., the network node such as an RSU) may provide the aggregated ML model information update to device 450 (e.g., a UE) via TX processor 416, which may transmit the aggregated ML model information update via antennas 420 to device 450. As an example, referring to FIG. 12, following receipt of the ML model information updates from participant nodes 1202, including the update from the UE and another update of a different UE, e.g., the third network node, in the same cluster, at step 1214, the leader node 1204 may aggregate the updates to generate updated ML model 1212 for the nodes (e.g., an updated cluster model Wₜ₊₁^{Ci} to be applied for the next FL iteration t+1). For example, the leader node 1204 may average or perform some other calculation on the respective model weights indicated by the participant nodes 1202. After the leader node 1204 generates the aggregated ML model information, the participant nodes 1202 may receive the aggregated ML model information from the leader node 1204. Thus, the leader node 1204 (the network node) may provide, to the participant node 1202 (the first network node), the aggregated ML model information (the aggregated ML model information update).

In one example, the aggregated ML model information update may further include a second aggregation of the ML model information update with a third ML model information update of a fourth network node in a second FL cluster. For instance, referring to FIG. 13, at step 1308, the leader node 1302 of a respective cluster may send the updated ML model Wₜ^{Ci} for its cluster Ci (the ML model information update in this example), which includes one or more previous aggregations 1307 of local ML model updates 1309 from follower nodes (e.g., participant nodes 1202 of FIG. 12), to the FL parameter server 1304. For instance, the leader node 1302 may send the aggregated ML model weights that it most recently generated after a given quantity of intra-cluster FL iterations, for the FL parameter server to further aggregate (in a second aggregation) with other aggregated ML model weights (the third ML model information update in this example) generated by other leader nodes (including the fourth network node in this examples) in other clusters (including the second FL cluster). After receiving the updated ML models from the cluster leaders, at step 1310, the FL parameter server 1304 may aggregate the updates to generate the updated global ML model 1311 for the leader nodes (e.g., an updated global model Wₜ₊₁^{G}). For example, the FL parameter server 1304 may average or perform some other calculation on the respective, aggregated model weights indicated by the leader nodes 1302. As a result, at step 1312, the FL parameter server may send the aggregated ML model information to the leader nodes 1302 to utilize for further training of respective intra-cluster ML models 1313 (beginning from the updated model Wₜ₊₁^{G}) such as described with respect to FIG. 12. The UE (e.g., participant node 1202 of FIG. 12) may subsequently obtain this further aggregated update (e.g., updated ML model 1212) from the leader node.

In one example, the second message may indicate the second network node is the FL cluster leader. In this example, the network node may obtain the first message from the second network node, and the first message may further include an identifier of the first network node. For instance, referring to FIG. 10, after the base station 1004 (the network node) obtains message 1014 (the first message) from the RSU 1006 (the second network node) including an identifier of the UE 1002 (the first network node), the base station 1004 may provide the message 1016 (the second message) indicating the RSU 1006 (the second network node) is a FL cluster leader (e.g., leader node 1204, 1302) of a cluster including this identified UE.

At 1526, the network node may obtain, from the second network node, a ML model information update. For example, 1526 may be performed by FL training component 1742. For instance, referring to FIG. 4, the controller/processor 475 in device 410 (the base station, FL parameter server, or other FL parameter network entity) may obtain the ML model information update from device 450 (e.g., the RSU, edge server, or other node) via RX processor 470, which may receive the ML model information update from device 450 via antennas 420. As an example, referring to FIG. 13, the FL parameter server 1304 (the network node) may obtain, from leader node 1302 (the second network node), aggregated ML model weights following intra-cluster training at step 1308 (the ML model information update).

At 1528, the network node may provide, to the second network node, an aggregated ML model information update including an aggregation of the ML model information update with a second ML model information update from a third network node in a second FL cluster. For example, 1528 may be performed by FL training component 1742. For instance, referring to FIG. 4, the controller/processor 475 in device 410 (e.g., the base station, FL parameter server, or other FL parameter network entity) may provide the aggregated ML model information update to device 450 (e.g., the RSU, edge server, or other node) via TX processor 416, which may transmit the aggregated ML model information update via antennas 420 to device 450. As an example, referring to FIG. 13, the FL parameter server 1304 (the network node) may provide to the leader node 1302 (the second network node), aggregated ML model information at step 1312 (the aggregated ML model information update) following inter-cluster training of respective, aggregated model weights (including the second ML model information update) indicated by leader nodes 1302 (including the third network node) of different clusters (e.g., cluster 1306).

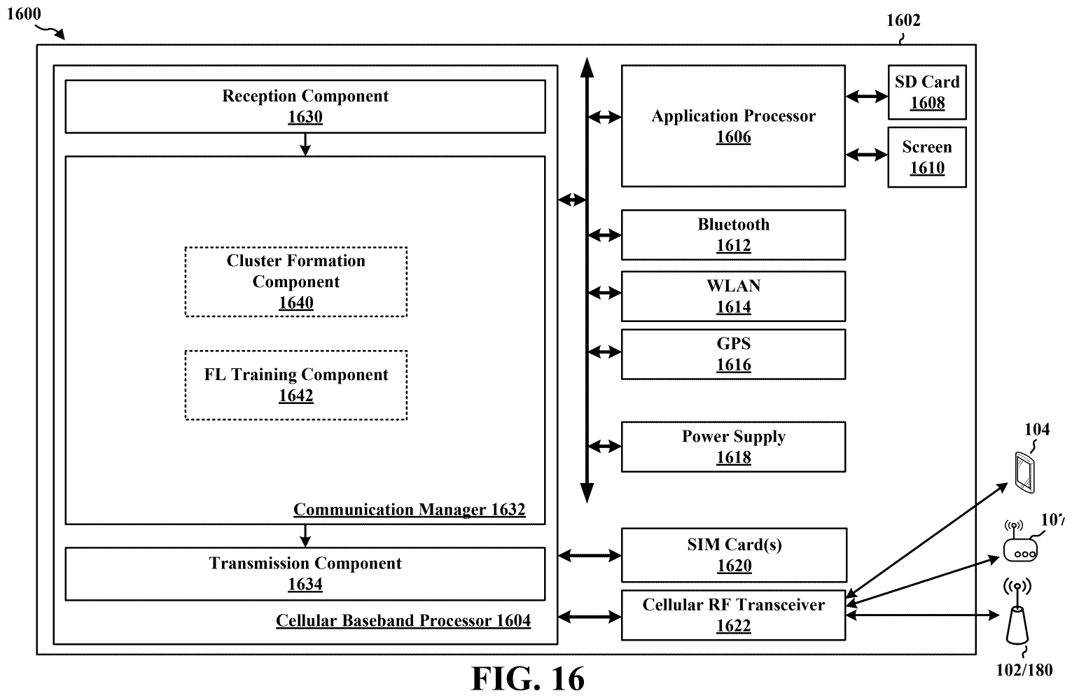

FIG. 16 is a diagram 1600 illustrating an example of a hardware implementation for an apparatus 1602. The apparatus 1602 is a UE and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104, RSU 107, BS 102/180, and/or other network node. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the device 410, 450 and may include the memory 460, 476 and/or at least one of the TX processor 416, 468, the RX processor 456, 470 and the controller/processor 459, 475. In one configuration, the apparatus 1602 may be a modem chip and include just the baseband processor 1604, and in another configuration, the apparatus 1602 may be the entire UE (e.g., see device 410, 450 of FIG. 4) and include the aforediscussed additional modules of the apparatus 1602.

The communication manager 1632 includes a cluster formation component 1640 that is configured to provide a first message including FL information, e.g., as described in connection with 1402. The cluster formation component 1640 is further configured to obtain a message indicating the second network node is a candidate to be a second FL cluster leader of the second FL cluster, where the first message is provided to the second network node in response to the message, e.g., as described in connection with 1404. The cluster formation component 1640 is further configured to provide a second message indicating a first network node, e.g., as described in connection with 1406. The cluster formation component 1640 is further configured to obtain an acknowledgment of the FL information from the first network node, where the second message is provided in response to the acknowledgment, e.g., as described in connection with 1408. The cluster formation component 1640 is further configured to provide the second message to the first network node in response to a lack of acknowledgment of the first message from the second network node within a message timeout window, e.g., as described in connection with 1410. The cluster formation component 1640 is further configured to obtain a third message indicating one of the first network node or a second network node as an FL cluster leader and indicating an FL cluster of the apparatus in response to the FL information, e.g., as described in connection with 1412.

The communication manager 1632 further includes an FL training component 1642 that is configured to obtain, from the FL cluster leader, a ML model configuration including an initial weight, e.g., as described in connection with 1414. The FL training component 1642 is further configured to provide, to the FL cluster leader, a ML model information update including an update to the initial weight, e.g., as described in connection with 1416. The FL training component 1642 is further configured to, e.g., as described in connection with obtain, from the FL cluster leader, an aggregated ML model information update including an aggregation of the ML model information update with a second ML model information update of a third network node in the FL cluster 1418.

The apparatus may include additional components that perform each of the blocks of the algorithm in the aforementioned flowchart of FIG. 14. As such, each block in the aforementioned flowchart of FIG. 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for providing a first message including FL information, the means for providing being further configured to provide a second message indicating a first network node; and means for obtaining a third message indicating one of the first network node or a second network node as an FL cluster leader and indicating an FL cluster of the apparatus in response to the FL information.

In one configuration, the FL information may comprise at least one of: a machine learning task of the UE, an available sensor coupled to the UE for the machine learning task, an available ML model associated with the machine learning task, or an available computation resource of the UE for the machine learning task.

In one configuration, the means for providing is configured to provide the first message periodically or in response to an event trigger.

In one configuration, the means for providing is configured to provide the first message in a broadcast.

In one configuration, the means for providing is configured to provide the first message to a second network node, where the first message may further include a request to join a second FL cluster of the second network node.

In one configuration, the means for obtaining is further configured to obtain a message indicating the second network node is a candidate to be a second FL cluster leader of the second FL cluster, where the first message is provided to the second network node in response to the message.

In one configuration, the means for obtaining is further configured to obtain an acknowledgment of the FL information from the first network node, where the second message is provided in response to the acknowledgment.

In one configuration, the means for providing is configured to provide the second message to the first network node in response to a lack of acknowledgment of the first message from the second network node within a message timeout window. In one configuration, the second message may further include the FL information.

In one configuration, the first network node and the second network node may be, for example, RSUs or edge servers.

In one configuration, the means for obtaining is configured to obtain the third message indicating the FL cluster leader and the FL cluster of the UE in a groupcast from the first network node.

In one configuration, the third message may indicate the first network node as the FL cluster leader.

In one configuration, the means for obtaining is further configured to obtain, from the FL cluster leader, a ML model configuration including an initial weight.

In one configuration, the means for providing is further configured to provide, to the FL cluster leader, a ML model information update including an update to the initial weight.

In one configuration, the means for obtaining is further configured to obtain, from the FL cluster leader, an aggregated ML model information update including an aggregation of the ML model information update with a second ML model information update of a third network node in the FL cluster.

In one configuration, the aggregated ML model information update may further include a second aggregation of the ML model information update with a third ML model information update of a fourth network node in a second FL cluster.

The aforementioned means may be one or more of the aforementioned components of the apparatus 1602 configured to perform the functions recited by the aforementioned means. As described supra, the apparatus 1602 may include the TX processor 416, 468, the RX processor 456, 470 and the controller/processor 459, 475. As such, in one configuration, the aforementioned means may be the TX processor 416, 468, the RX processor 456, 470 and the controller/processor 459, 475 configured to perform the functions recited by the aforementioned means.

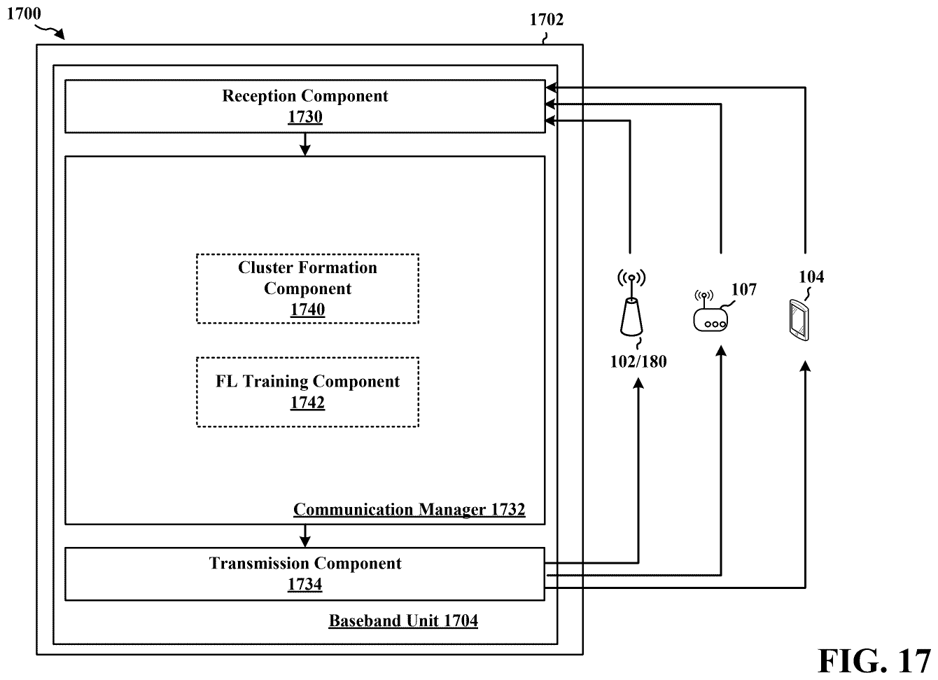

FIG. 17 is a diagram 1700 illustrating an example of a hardware implementation for an apparatus 1702. The apparatus 1702 is a network node such as a RSU or BS and includes a baseband unit 1704. The baseband unit 1704 may communicate through a cellular RF transceiver with the UE 104, RSU 107, BS 102/180, or other network node. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the device 410, 450 and may include the memory 460, 476 and/or at least one of the TX processor 416, 468, the RX processor 456, 470 and the controller/processor 459, 475.

The communication manager 1732 includes a cluster formation component 1740 that is configured to obtain a first message including FL information of a first network node, e.g., as described in connection with 1502. The cluster formation component 1740 is further configured to provide a third message to the first network node indicating the apparatus is a candidate to be the FL cluster leader of the FL cluster, where the first message is responsive to the third message and indicates a request from the first network node to join a FL cluster, e.g., as described in connection with 1504. The cluster formation component 1740 is further configured to provide an acknowledgment to the first network node in response to the first message, e.g., as described in connection with 1506. The cluster formation component 1740 is further configured to obtain a third message from the first network node indicating an identifier of the apparatus or of the second network node in response to the acknowledgment, e.g., as described in connection with 1508. The cluster formation component 1740 is further configured to provide, to a FL parameter network entity, a fourth message including the FL information and a second identifier of the first network node in response to the third message indicating the identifier of the apparatus, e.g., as described in connection with 1510. The cluster formation component 1740 is further configured to provide, to a FL parameter network entity, a fourth message including a second identifier of the first network node in response to the third message indicating the identifier of the second network node, e.g., as described in connection with 1512. The cluster formation component 1740 is further configured to provide a second message indicating an FL cluster of the first network node in response to the FL information, where the second message indicates one of the apparatus or a second network node as an FL cluster leader of the FL cluster, e.g., as described in connection with 1514. The cluster formation component 1740 is further configured to obtain, from a FL parameter network entity, a third message indicating the FL cluster and indicating the apparatus is the FL cluster leader of the FL cluster, where the second message is provided to the first network node in response to the third message, e.g., as described in connection with 1516.

The communication manager 1732 includes an FL training component 1742 that is configured to provide, to the first network node, a ML model configuration including an initial weight, e.g., as described in connection with 1520. The FL training component 1742 is further configured to obtain, from the first network node, a ML model information update including an update to the initial weight, e.g., as described in connection with 1522. The FL training component 1742 is further configured to provide, to the first network node, an aggregated ML model information update including an aggregation of the ML model information update with a second ML model information update of a third network node in the FL cluster, e.g., as described in connection with 1524. The FL training component 1742 is further configured to obtain, from the second network node, a ML model information update, e.g., as described in connection with 1526. The FL training component 1742 is further configured to provide, to the second network node, an aggregated ML model information update including an aggregation of the ML model information update with a second ML model information update from a third network node in a second FL cluster, e.g., as described in connection with 1528.

The apparatus may include additional components that perform each of the blocks of the algorithm in the aforementioned flowcharts of FIGS. 15A-15B. As such, each block in the aforementioned flowcharts of FIGS. 15A-15B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the baseband unit 1704, includes means for obtaining a first message including FL information of a first network node, and means for providing a second message indicating an FL cluster of the first network node in response to the FL information, where the second message indicates one of the apparatus or a second network node as an FL cluster leader of the FL cluster.

In one configuration, the means for providing may be further configured to provide a third message to the first network node indicating the apparatus is a candidate to be a FL cluster leader of an FL cluster, where the first message is responsive to the third message and indicates a request from the first network node to join a FL cluster.

In one configuration, the means for providing may be further configured to provide the third message periodically or in response to an event trigger.

In one configuration, the means for providing may be further configured to provide the third message in a broadcast or in a groupcast to a plurality of network nodes including the first network node.

In one configuration, the third message may include second FL information of the apparatus.

In one configuration, the means for providing may be further configured to provide an acknowledgment to the first network node in response to the first message.

In one configuration, the means for obtaining may be further configured to obtain a third message from the first network node indicating an identifier of the apparatus or of a second network node in response to the acknowledgment.

In one configuration, the means for providing may be further configured to provide, to a FL parameter network entity, a fourth message including the FL information and a second identifier of the first network node in response to the third message indicating the identifier of the apparatus. In one configuration, the fourth message may further include second FL information of the apparatus.

In one configuration, the means for providing may be further configured to provide, to a FL parameter network entity, a fourth message including a second identifier of the first network node in response to the third message indicating the identifier of the second network node.

In one configuration, the means for obtaining may be further configured to obtain, from a FL parameter network entity, a third message indicating the FL cluster and indicating the apparatus is the FL cluster leader of the FL cluster, where the second message is provided to the first network node in response to the third message.

In one configuration, the second message may be groupcast to a plurality of network nodes including the first network node in the FL cluster.

In one configuration, the second message may acknowledge an admission of the first network node to the FL cluster.

In one configuration, the means for providing may be further configured to provide, to the first network node, a ML model configuration including an initial weight.

In one configuration, the means for obtaining may be further configured to obtain, from the first network node, a ML model information update including an update to the initial weight.

In one configuration, the means for providing may be further configured to provide, to the first network node, an aggregated ML model information update including an aggregation of the ML model information update with a second ML model information update of a third network node in the FL cluster.

In one configuration, the aggregated ML model information update may further include a second aggregation of the ML model information update with a third ML model information update of a fourth network node in a second FL cluster.

In one configuration, the second message may indicate the second network node is the FL cluster leader. In one configuration, the network node may obtain the first message from the second network node, and the first message may further include an identifier of the first network node.

In one configuration, the means for obtaining may be further configured to obtain, from the second network node, a ML model information update

In one configuration, the means for providing may be further configured to provide, to the second network node, an aggregated ML model information update including an aggregation of the ML model information update with a second ML model information update from a third network node in a second FL cluster.

The aforementioned means may be one or more of the aforementioned components of the apparatus 1702 configured to perform the functions recited by the aforementioned means. As described supra, the apparatus 1702 may include the TX processor 416, 468, the RX processor 456, 470 and the controller/processor 459, 475. As such, in one configuration, the aforementioned means may be the TX processor 416, 468, the RX processor 456, 470 and the controller/processor 459, 475 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

The term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, comprising: a processor; memory coupled with the processor, the processor configured to: provide a first message including federated learning (FL) information; provide a second message indicating a first network node; and obtain a third message indicating one of the first network node or a second network node as an FL cluster leader and indicating an FL cluster of the apparatus based on the FL information.

Example 2 is the apparatus of Example 1, wherein FL information comprises at least one of: a machine learning task of the apparatus; an available sensor coupled to the apparatus for the machine learning task; an available ML model associated with the machine learning task; or an available computation resource of the apparatus for the machine learning task; and wherein each of the first network node and the second network node is a RSU or an edge server; and wherein the apparatus is a UE.

Example 3 is the apparatus of Examples 1 or 2, wherein the processor is configured to provide the first message periodically or in response to an event trigger.

Example 4 is the apparatus of any of Examples 1 to 3, wherein the processor is configured to provide the first message in a broadcast.

Example 5 is the apparatus of any of Examples 1 to 4, wherein the processor is configured to: obtain an acknowledgment of the FL information from the first network node, wherein the processor is configured to provide the second message in response to the acknowledgment.

Example 6 is the apparatus of any of Examples 1 to 5, wherein the processor is configured to obtain the third message indicating the FL cluster leader and the FL cluster of the apparatus in a groupcast from the first network node.

Example 7 is the apparatus of Examples 1 or 2, wherein the processor is configured to provide the first message to the second network node, the first message further including a request to join a second FL cluster of the second network node.

Example 8 is the apparatus of Example 7, wherein the processor is further configured to: obtain a message indicating the second network node is a candidate to be a second FL cluster leader of the second FL cluster; wherein the processor is configured to provide the first message to the second network node in response to the message.

Example 9 is the apparatus of Example 8, wherein the second message further includes the FL information; and wherein the processor is configured to provide the second message to the first network node in response to a lack of acknowledgment of the first message from the second network node within a message timeout window; wherein the third message indicates the first network node as the FL cluster leader.

Example 10 is the apparatus of any of Examples 1 to 9, wherein the processor is further configured to: obtain, from the FL cluster leader, a machine learning (ML) model configuration including an initial weight; provide, to the FL cluster leader, a ML model information update including an update to the initial weight; and obtain, from the FL cluster leader, an aggregated ML model information update including an aggregation of the ML model information update with a second ML model information update of a third network node in the FL cluster.

Example 11 is the apparatus of Example 10, wherein the aggregated ML model information update further includes a second aggregation of the ML model information update with a third ML model information update of a fourth network node in a second FL cluster.

Example 12 is an apparatus for wireless communication, comprising: a processor; memory coupled with the processor, the processor configured to: obtain a first message including FL information of a first network node; and provide a second message indicating an FL cluster of the first network node based on the FL information, wherein the second message indicates one of the apparatus or a second network node as an FL cluster leader of the FL cluster.

Example 13 is the apparatus of Example 12, wherein the processor is further configured to: provide an acknowledgment to the first network node in response to the first message; and obtain a third message from the first network node indicating an identifier of the apparatus or of the second network node in response to the acknowledgment.

Example 14 is the apparatus of Example 13, wherein the processor is further configured to: provide, to a FL parameter network entity, a fourth message including the FL information and a second identifier of the first network node in response to the third message indicating the identifier of the apparatus.

Example 15 is the apparatus of Example 14, wherein the fourth message further includes second FL information of the apparatus.

Example 16 is the apparatus of Example 13, wherein the processor is further configured to: provide, to a FL parameter network entity, a fourth message including a second identifier of the first network node in response to the third message indicating the identifier of the second network node.

Example 17 is the apparatus of any of Examples 12 to 16, wherein the processor is further configured to: obtain, from a FL parameter network entity, a third message indicating the FL cluster and indicating the apparatus is the FL cluster leader of the FL cluster; wherein the second message is provided to the first network node in response to the third message.

Example 18 is the apparatus of any of Examples 12 to 17, wherein the processor is configured to groupcast the second message to a plurality of network nodes including the first network node in the FL cluster.

Example 19 is the apparatus of Example 12, wherein the processor is further configured to: provide a third message to the first network node indicating the apparatus is a candidate to be the FL cluster leader of the FL cluster; wherein the first message is responsive to the third message and indicates a request from the first network node to join the FL cluster.

Example 20 is the apparatus of Example 19, wherein the processor is configured to provide the third message periodically or in response to an event trigger.

Example 21 is the apparatus of Examples 19 or 20, wherein the processor is configured to provide the third message in a broadcast or in a groupcast to a plurality of network nodes including the first network node.

Example 22 is the apparatus of any of Examples 19 to 21, wherein the third message includes second FL information of the apparatus.

Example 23 is the apparatus of any of Examples 19 to 22, wherein the second message acknowledges an admission of the first network node to the FL cluster.

Example 24 is the apparatus of any of Examples 12 to 23, wherein in response to the second message indicating the apparatus is the FL cluster leader of the FL cluster, the processor is further configured to: provide, to the first network node, a machine learning (ML) model configuration including an initial weight; obtain, from the first network node, a ML model information update including an update to the initial weight; and provide, to the first network node, an aggregated ML model information update including an aggregation of the ML model information update with a second ML model information update of a third network node in the FL cluster.

Example 25 is the apparatus of Example 24, wherein the aggregated ML model information update further includes a second aggregation of the ML model information update with a third ML model information update of a fourth network node in a second FL cluster.

Example 26 is the apparatus of any of Examples 12 to 23, wherein the second message indicates the second network node is the FL cluster leader.

Example 27 is the apparatus of Example 26, wherein the processor is configured to obtain the first message from the second network node; and wherein the first message further includes an identifier of the first network node.

Example 28 is the apparatus of any of Examples 12 to 23, wherein the processor is further configured to: obtain, from the second network node, a machine learning (ML) model information update; and provide, to the second network node, an aggregated ML model information update including an aggregation of the ML model information update with a second ML model information update from a third network node in a second FL cluster.

Example 29 is a method of wireless communication at a user equipment (UE), comprising: providing a first message including federated learning (FL) information; providing a second message indicating a first network node; and obtaining a third message indicating one of the first network node or a second network node as an FL cluster leader and indicating an FL cluster of the UE based on the FL information.

Example 30 is a method of wireless communication at a first network node, comprising: obtaining a first message including federated learning (FL) information of a second network node; and providing a second message indicating an FL cluster of the second network node based on the FL information, wherein the second message indicates one of the first network node or a third network node as an FL cluster leader of the FL cluster.

What is claimed is:

1. An apparatus for wireless communication, comprising:
a processor; and
memory coupled with the processor, the processor configured to:
provide a first message including federated learning (FL) information;
provide a second message indicating a first network node; and
obtain a third message indicating one of the first network node or a second network node as an FL cluster leader and indicating an FL cluster of the apparatus based on the FL information.

2. The apparatus of claim 1,
wherein FL information comprises information related to at least one of:
a machine learning task of the apparatus;
an available sensor coupled to the apparatus for the machine learning task;
an available ML model associated with the machine learning task; or
an available computation resource of the apparatus for the machine learning task;
and
wherein each of the first network node and the second network node is a road side unit (RSU) or an edge server; and
wherein the apparatus is a UE.

3. The apparatus of claim 1, wherein the processor is configured to provide the first message periodically or in response to an event trigger.

4. The apparatus of claim 1, wherein the processor is configured to provide the first message in a broadcast.

5. The apparatus of claim 1, wherein the processor is configured to:
obtain an acknowledgment of the FL information from the first network node, wherein the processor is configured to provide the second message in response to the acknowledgment.

6. The apparatus of claim 1, wherein the processor is configured to obtain the third message indicating the FL cluster leader and the FL cluster of the apparatus in a groupcast from the first network node.

7. The apparatus of claim 1, wherein the processor is configured to provide the first message to the second network node, the first message further including a request to join a second FL cluster of the second network node.

8. The apparatus of claim 7, wherein the processor is further configured to:
obtain a message indicating the second network node is a candidate to be a second FL cluster leader of the second FL cluster;
wherein the processor is configured to provide the first message to the second network node in response to the message.

9. The apparatus of claim 8,
wherein the second message further includes the FL information; and
wherein the processor is configured to provide the second message to the first network node in response to a lack of acknowledgment of the first message from the second network node within a message timeout window;
wherein the third message indicates the first network node as the FL cluster leader.

10. The apparatus of claim 1, wherein the processor is further configured to:
obtain, from the FL cluster leader, a machine learning (ML) model configuration including an initial weight;
provide, to the FL cluster leader, a ML model information update including an update to the initial weight; and
obtain, from the FL cluster leader, an aggregated ML model information update including an aggregation of the ML model information update with a second ML model information update of a third network node in the FL cluster.

11. The apparatus of claim 10, wherein the aggregated ML model information update further includes a second aggregation of the ML model information update with a third ML model information update of a fourth network node in a second FL cluster.

12. An apparatus for wireless communication, comprising:
a processor; and
memory coupled with the processor, the processor configured to:
obtain a first message including federated learning (FL) information of a first network node; and
provide a second message indicating an FL cluster of the first network node based on the FL information, wherein the second message indicates one of the apparatus or a second network node as an FL cluster leader of the FL cluster.

13. The apparatus of claim 12, wherein the processor is further configured to:
provide an acknowledgment to the first network node in response to the first message; and
obtain a third message from the first network node indicating an identifier of the apparatus or of the second network node in response to the acknowledgment.

14. The apparatus of claim 13, wherein the processor is further configured to:
provide, to a FL parameter network entity, a fourth message including the FL information and a second identifier of the first network node in response to the third message indicating the identifier of the apparatus.

15. The apparatus of claim 14, wherein the fourth message further includes second FL information of the apparatus.

16. The apparatus of claim 13, wherein the processor is further configured to:
provide, to a FL parameter network entity, a fourth message including a second identifier of the first network node in response to the third message indicating the identifier of the second network node.

17. The apparatus of claim 12, wherein the processor is further configured to:
obtain, from a FL parameter network entity, a third message indicating the FL cluster and indicating the apparatus is the FL cluster leader of the FL cluster;
wherein the second message is provided to the first network node in response to the third message.

18. The apparatus of claim 12, wherein the processor is configured to groupcast the second message to a plurality of network nodes including the first network node in the FL cluster.

19. The apparatus of claim 12, wherein the processor is further configured to:
provide a third message to the first network node indicating the apparatus is a candidate to be the FL cluster leader of the FL cluster;
wherein the first message is responsive to the third message and indicates a request from the first network node to join the FL cluster.

20. The apparatus of claim 19, wherein the processor is configured to provide the third message periodically or in response to an event trigger.

21. The apparatus of claim 19, wherein the processor is configured to provide the third message in a broadcast or in a groupcast to a plurality of network nodes including the first network node.

22. The apparatus of claim 19, wherein the third message includes second FL information of the apparatus.

23. The apparatus of claim 19, wherein the second message acknowledges an admission of the first network node to the FL cluster.

24. The apparatus of claim 12, wherein in response to the second message indicating the apparatus is the FL cluster leader of the FL cluster, the processor is further configured to:
provide, to the first network node, a machine learning (ML) model configuration including an initial weight;
obtain, from the first network node, a ML model information update including an update to the initial weight; and
provide, to the first network node, an aggregated ML model information update including an aggregation of the ML model information update with a second ML model information update of a third network node in the FL cluster.

25. The apparatus of claim 24, wherein the aggregated ML model information update further includes a second aggregation of the ML model information update with a third ML model information update of a fourth network node in a second FL cluster.

26. The apparatus of claim 12, wherein the second message indicates the second network node is the FL cluster leader.

27. The apparatus of claim 26,
wherein the processor is configured to obtain the first message from the second network node; and
wherein the first message further includes an identifier of the first network node.

28. The apparatus of claim 12, wherein the processor is further configured to:
obtain, from the second network node, a machine learning (ML) model information update; and
provide, to the second network node, an aggregated ML model information update including an aggregation of the ML model information update with a second ML model information update from a third network node in a second FL cluster.

29. A method of wireless communication at a user equipment (UE), comprising:
providing a first message including federated learning (FL) information;
providing a second message indicating a first network node; and
obtaining a third message indicating one of the first network node or a second network node as an FL cluster leader and indicating an FL cluster of the UE based on the FL information.

30. A method of wireless communication at a first network node, comprising:
obtaining a first message including federated learning (FL) information of a second network node; and
providing a second message indicating an FL cluster of the second network node based on the FL information, wherein the second message indicates one of the first network node or a third network node as an FL cluster leader of the FL cluster.
